(19) United States
(12) Patent Application Publication
(10) Pub. No.: US 2023/0364756 A1
(43) Pub. Date: Nov. 16, 2023

(54) POWER TOOL

(71) Applicant: MAKITA CORPORATION, Anjo-shi (JP)

(72) Inventors: Akihiro HOZUMI, Anjo-shi (JP); Makoto CHIKARAISHI, Anjo-shi (JP); Kazunori KINOSHITA, Anjo-shi (JP)

(73) Assignee: MAKITA CORPORATION, Anjo-shi (JP)

(21) Appl. No.: 18/303,616

(22) Filed: Apr. 20, 2023

(30) Foreign Application Priority Data
May 11, 2022 (JP) 2022-078035
Dec. 14, 2022 (JP) 2022-199223

(51) Int. Cl. B25B 23/18; B25B 21/02; B25F 5/00; F21V 33/00; F21V 29/503; F21V 29/70

(52) U.S. Cl. CPC B25B 23/18; B25B 21/02; B25F 5/008; B25F 5/001; F21V 33/0084; F21V 29/503; F21V 29/70; F21Y 2115/10

(57) ABSTRACT

A power tool includes a motor, an output shaft that is rotated by a rotational force of the motor, a chip-on-board light emitting diode disposed around the output shaft, and a white translucent optical member including a light refraction portion that refracts light emitted from the chip-on-board light emitting diode. In at least one cross section parallel to and passing through a rotation axis of the output shaft, a shape of the light refraction portion is line-symmetric with respect to the rotation axis.

### CROSS-REFERENCE

The present application claims priority to and incorporates by reference the entire contents of Japanese Patent Application No. 2022-078035 filed in Japan on May 11, 2022 and Japanese Patent Application No. 2022-199223 filed in Japan on Dec. 14, 2022.

### TECHNICAL FIELD

The technology disclosed in the present specification relates to a power tool.

### BACKGROUND ART

In the technical field related to power tools, a kown illumination system for a power tool is disclosed in US 2016/0354889 A.

In US 2016/0354889 A, the illumination system for a power tool includes a chip-on-board light emitting diode (COB LED). The chip-on-board light emitting diode emits (outputs) a higher amount of light and brightly illuminates a work target or a work space. On the other hand, since the chip-on-board light emitting diode generates a higher amount of heat, the temperature of the chip-on-board light emitting diode may excessively increase. When the temperature of the chip-on-board light emitting diode is excessively increased, the chip-on-board light emitting diode may be deteriorated or the life of the chip-on-board light emitting diode may be shortened. Furthermore, when a shadow is formed on the work target, a worker may have difficulty in visually recognizing the work target.

An object of the present disclosure is to disclose techniques for suppressing an excessive rise in temperature of a chip-on-board light emitting diode. Furthermore, an object of the present disclosure is to disclose techniques for suppressing generation of a shadow on a work target.

### SUMMARY OF THE INVENTION

In one non-limiting aspect of the present disclosure, a power tool may includes: a motor; an output shaft that is rotated by a rotational force of the motor; a chip-on-board light emitting diode disposed around the output shaft; and a heat dissipation device that dissipates heat of the chip-on-board light emitting diode.

In one non-limiting aspect of the present disclosure, a power tool may include: a motor; an output shaft that is rotated by a rotational force of the motor; a chip-on-board light emitting diode disposed around the output shaft; and a white translucent optical member including a light refraction portion that refracts light emitted from the chip-on-board light emitting diode. In at least one cross section parallel to a rotation axis of the output shaft and passing through the rotation axis, a shape of the light refraction portion may be line-symmetric with respect to the rotation axis.

### BRIEF DESCRIPTION OF THE DRAWINGS

FIG. 1 is an oblique view, viewed from the front, which illustrates a power tool according to a first embodiment;

FIG. 2 is a side view illustrating the power tool according to the first embodiment;

FIG. 3 is a cross-sectional view illustrating the power tool according to the first embodiment;

FIG. 4 is a cross-sectional view illustrating an upper portion of the power tool according to the first embodiment;

FIG. 5 is a diagram schematically illustrating a chip-on-board light emitting diode according to the first embodiment;

FIG. 6 is an oblique view, viewed from the front, which illustrates a light unit according to the first embodiment;

FIG. 7 is an oblique view, viewed from the rear, which illustrates the light unit according to the first embodiment;

FIG. 8 is an exploded oblique view, viewed from the front, which illustrates the light unit according to the first embodiment;

FIG. 9 is an exploded oblique view, viewed from the rear, which illustrates the light unit according to the first embodiment;

FIG. 10 is a rear view of a light cover according to the first embodiment;

FIG. 11 is a front view of the upper portion of the power tool according to the first embodiment;

FIG. 12 is an exploded oblique view, viewed from the front, which illustrates the upper portion of the power tool according to the first embodiment;

FIG. 13 is an exploded oblique view, viewed from the rear, which illustrates the upper portion of the power tool according to the first embodiment;

FIG. 14 is a cross-sectional view illustrating a part of the power tool according to the first embodiment;

FIG. 15 is a cross-sectional view illustrating a part of a power tool according to a second embodiment;

FIG. 16 is a cross-sectional view illustrating a part of a power tool according to a third embodiment;

FIG. 17 is an exploded oblique view, viewed from the front, which illustrates an upper portion of the power tool according to the third embodiment;

FIG. 18 is an oblique view, viewed from the front, which illustrates a power tool according to a fourth embodiment;

FIG. 19 is a cross-sectional view illustrating the power tool according to the fourth embodiment;

FIG. 20 is a front view of a light unit according to a fifth embodiment;

FIG. 21 is a longitudinal cross-sectional view illustrating the light unit according to the fifth embodiment; and

FIG. 22 is a transverse cross-sectional view illustrating the light unit according to the fifth embodiment.

### DETAILED DESCRIPTION OF THE INVENTION

In one or more embodiments, a power tool may include: a motor; an output shaft that is rotated by a rotational force of the motor; a chip-on-board light emitting diode disposed around the output shaft; and a white translucent optical member including a light refraction portion that refracts light emitted from the chip-on-board light emitting diode. In at least one cross section parallel to a rotation axis of the output shaft and passing through the rotation axis, a shape of the light refraction portion is line-symmetric with respect to the rotation axis.

According to the above configuration, since the chip-on-board light emitting diode has a ring shape disposed around the output shaft and the light refraction portion is line-symmetric, light is emitted from the light refraction portion in a ring shape. This prevents a shadow from being formed on a work target.

In one or more embodiments, the light refraction portion may include an entrance surface on which light emitted from the chip-on-board light emitting diode is incident and an exit surface from which light transmitted through the light refraction portion is output. Each of the entrance surface and the exit surface may be line-symmetric with respect to the rotation axis.

According to the above configuration, since each of the entrance surface and the exit surface has a ring shape and line symmetry, light is emitted from the optical member in a ring shape. That is, the entire optical member does not need to be line-symmetric, and it is sufficient that each of the entrance surface and the exit surface is line-symmetric.

In one or more embodiments, the entrance surface may be inclined rearward toward a radial outside. The exit surface may be orthogonal to an axis parallel to the rotation axis.

According to the above configuration, the light appropriately spreads from the light refraction portion, and the work target is brightly illuminated.

In one or more embodiments, in all cross sections passing through the rotation axis, a shape of the light refraction portion may be line-symmetric with respect to the rotation axis.

According to the above configuration, since the shape of the light refraction portion is line-symmetric with respect to the rotation axis in all cross sections parallel to the rotation axis and passing through the rotation axis, the light is emitted from the light refraction portion in a ring shape. The chip-on-board light emitting diode brightly illuminates the work target.

In one or more embodiments, a power tool may include: a motor; an output shaft that is rotated by a rotational force of the motor; a chip-on-board light emitting diode disposed around the output shaft; and a heat dissipation device that dissipates heat of the chip-on-board light emitting diode.

According to the above configuration, since the heat of the chip-on-board light emitting diode is dissipated by the heat dissipation device, an excessive rise in temperature of the chip-on-board light emitting diode is suppressed.

In one or more embodiments, the heat dissipation device may include a heat dissipation member to which heat of the chip-on-board light emitting diode is transferred.

According to the above configuration, since the heat of the chip-on-board light emitting diode is dissipated via the heat dissipation member, an excessive rise in temperature of the chip-on-board light emitting diode is suppressed.

In one or more embodiments, the power tool may include: a speed reduction mechanism configured to transmit a rotational force of the motor to the output shaft; and a gear case that accommodates therein the speed reduction mechanism. The heat dissipation member may include a gear case.

According to the above configuration, the heat of the chip-on-board light emitting diode is dissipated through the gear case.

In one or more embodiments, the power tool may include a thermal interface material that transfers heat of the chip-on-board light emitting diode to the gear case.

According to the above configuration, the heat of the chip-on-board light emitting diode is efficiently transferred to the gear case via the thermal interface material.

In one or more embodiments, the thermal interface material may be in contact with a substrate of the chip-on-board light emitting diode and the gear case.

According to the above configuration, the heat of the chip-on-board light emitting diode is efficiently transferred to the gear case via the thermal interface material.

In one or more embodiments, the thermal interface material may have a sheet shape.

According to the above configuration, in a case where the thermal interface material is a solid thermal interface sheet, the thermal interface sheet can be sandwiched between the substrate of the chip-on-board light emitting diode and the gear case.

In one or more embodiments, the gear case may include: a rear cylindrical portion that accommodates therein the speed reduction mechanism; a front cylindrical portion that holds a bearing that supports the output shaft; and an annular portion that connects a front end portion of the rear cylindrical portion and a rear end portion of the front cylindrical portion. The chip-on-board light emitting diode may be disposed around the front cylindrical portion. The thermal interface material may be in contact with the substrate and the annular portion.

According to the above configuration, an increase in size of the power tool is suppressed, and the heat of the chip-on-board light emitting diode is efficiently transmitted to the annular portion of the gear case via the thermal interface material.

In one or more embodiments, the power tool may include a case cover that covers a surface of the rear cylindrical portion. The heat dissipation member may include the case cover. The thermal interface material may be in contact with the case cover.

According to the above configuration, the heat of the chip-on-board light emitting diode is efficiently dissipated through the case cover.

In one or more embodiments, the heat dissipation member may be in contact with a substrate of the chip-on-board light emitting diode.

According to the above configuration, the heat of the chip-on-board light emitting diode is efficiently transferred to the heat dissipation member.

In one or more embodiments, an LED chip of the chip-on-board light emitting diode may be disposed on a front surface of the substrate. The heat dissipation member may include a heat sink that is in contact with a rear surface of the substrate.

According to the above configuration, the heat of the chip-on-board light emitting diode is efficiently dissipated through the heat sink.

In one or more embodiments, the power tool may include: a speed reduction mechanism configured to transmit a rotational force of the motor to the output shaft; and a gear case that accommodates therein the speed reduction mechanism. The gear case may include a rear cylindrical portion that accommodates the speed reduction mechanism, a front cylindrical portion that holds a bearing that supports the output shaft, and an annular portion that connects a front end portion of the rear cylindrical portion and a rear end portion of the front cylindrical portion. The chip-on-board light emitting diode may be disposed around the front cylindrical portion. The heat sink may face the annular portion with a gap interposed between the heat sink and the annular portion.

According to the above configuration, the heat of the chip-on-board light emitting diode is efficiently dissipated to an atmospheric space via the heat sink.

In one or more embodiments, the power tool may include a case cover that covers a surface of the rear cylindrical portion. The heat sink may face the case cover with a gap interposed between the heat sink and the case cover.

According to the above configuration, the heat of the chip-on-board light emitting diode is efficiently dissipated to an atmospheric space via the heat sink.

In one or more embodiments, the power tool may include a light cover including a light transmission portion through which light emitted from an LED chip of the chip-on-board light emitting diode passes. The heat dissipation member may include the light cover.

According to the above configuration, the heat of the chip-on-board light emitting diode is efficiently dissipated through the light cover.

In one or more embodiments, the substrate may include a circular ring portion, and the LED chip may be disposed on a front surface of the circular ring portion. The light cover may include: an outer cylindrical portion disposed radially outside with respect to the circular ring portion; and an inner cylindrical portion disposed radially inside with respect to the circular ring portion. The light transmission portion may be disposed so as to connect a front end portion of the outer cylindrical portion and a front end portion of the inner cylindrical portion. The substrate may be in contact with at least one of the outer cylindrical portion and the inner cylindrical portion in a state of being spaced apart from the light transmission portion.

According to the above configuration, the heat of the chip-on-board light emitting diode is efficiently transferred to the light cover.

In one or more embodiments, a substrate of the chip-on-board light emitting diode may be fixed to the heat dissipation member via an adhesive. Heat of the chip-on-board light emitting diode may be transferred to the heat dissipation member via the adhesive.

According to the above configuration, the heat of the chip-on-board light emitting diode is efficiently transferred to the heat dissipation member via the adhesive.

In one or more embodiments, the power tool may include a light cover including a light transmission portion through which light emitted from an LED chip of the chip-on-board light emitting diode passes. The heat dissipation member may include the light cover.

According to the above configuration, the heat of the chip-on-board light emitting diode is efficiently transferred to the light cover via the adhesive.

In one or more embodiments, the substrate may include a circular ring portion, and the LED chip may be disposed on a front surface of the circular ring portion. The light cover may include: an outer cylindrical portion disposed radially outside with respect to the circular ring portion; and an inner cylindrical portion disposed radially inside with respect to the circular ring portion. The light transmission portion may be disposed so as to connect a front end portion of the outer cylindrical portion and a front end portion of the inner cylindrical portion. The substrate may be fixed to the inner cylindrical portion via an adhesive.

According to the above configuration, the heat of the chip-on-board light emitting diode is efficiently transferred to the light cover via the adhesive.

In one or more embodiments, the power tool may include: a speed reduction mechanism configured to transmits a rotational force of the motor to the output shaft; and a gear case that accommodates therein the speed reduction mechanism. The gear case may include: a rear cylindrical portion that accommodates therein the speed reduction mechanism; a front cylindrical portion that holds a bearing that supports the output shaft; and an annular portion that connects a front end portion of the rear cylindrical portion and a rear end portion of the front cylindrical portion. The inner cylindrical portion may be disposed around the front cylindrical portion and fixed to the front cylindrical portion.

According to the above configuration, the chip-on-board light emitting diode is fixed to the front cylindrical portion of the gear case via the light cover.

In one or more embodiments, the output shaft may include an anvil. The power tool may include an impact mechanism to which a rotational force of the motor is transmitted via the speed reduction mechanism and that impacts the anvil in a rotation direction. The gear case may be a hammer case that accommodates therein the speed reduction mechanism and the impact mechanism.

According to the above configuration, the chip-on-board light emitting diode is applied to an impact tool.

In one or more embodiments, the power tool may include a fan that is rotated by a rotational force of the motor. The heat dissipation device may include the fan. Air may be supplied from the fan to the chip-on-board light emitting diode.

According to the above configuration, the heat of the chip-on-board light emitting diode is dissipated by the air supplied from the fan.

Hereinafter, embodiments will be described with reference to the drawings. In the embodiments, a positional relationships among parts will be described using the terms “left”, “right”, “front”, “rear”, “up”, and “down”. These terms indicate the relative positions or directions, using the center of a power tool as a reference.

### First Embodiment

Power Tool

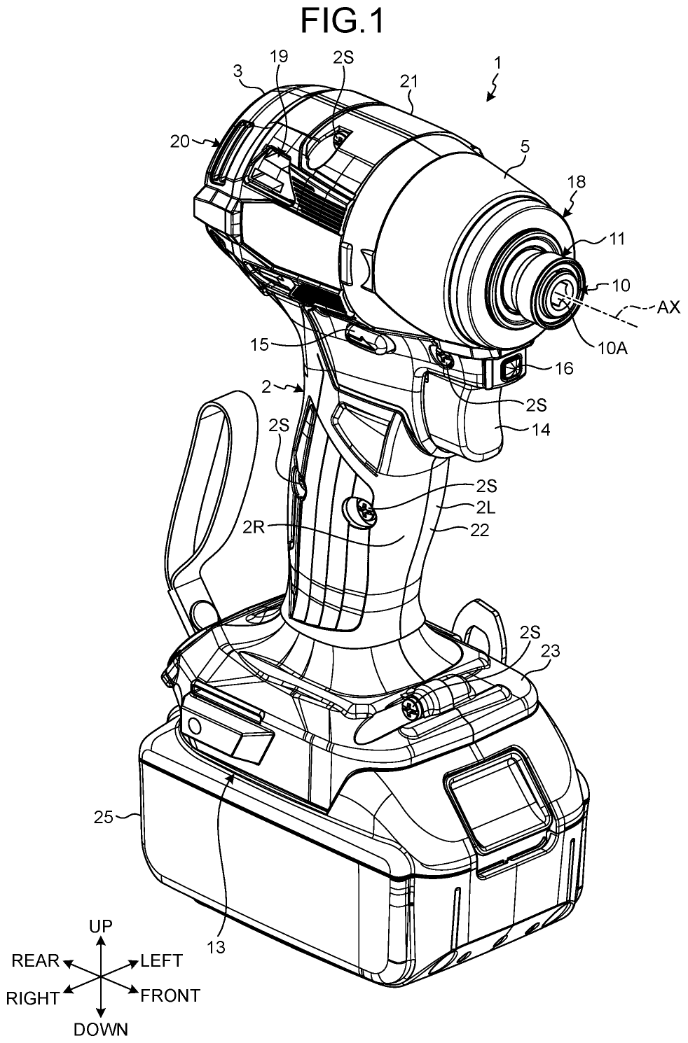

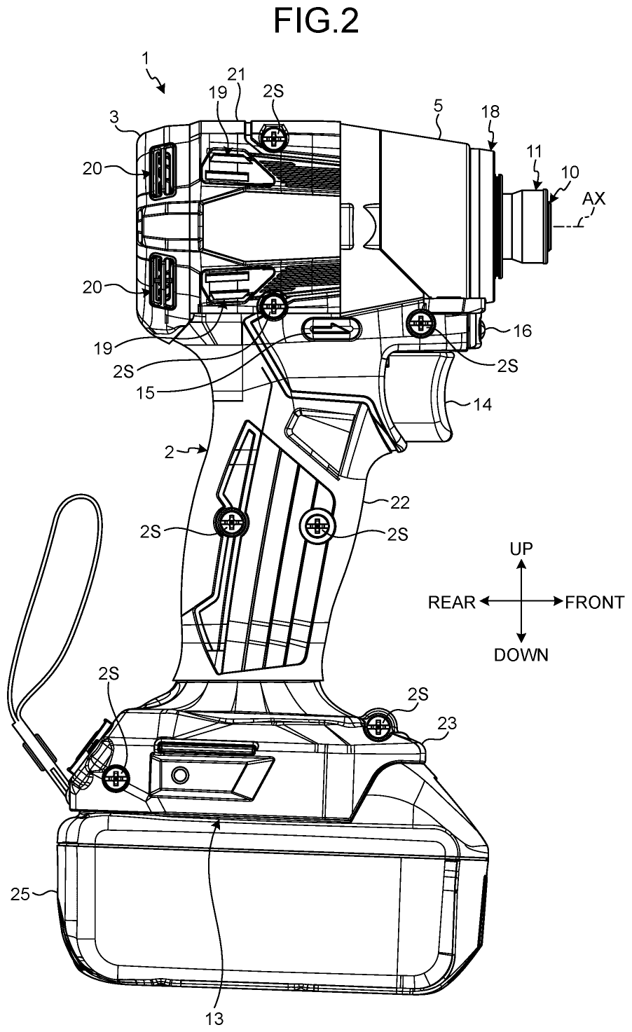

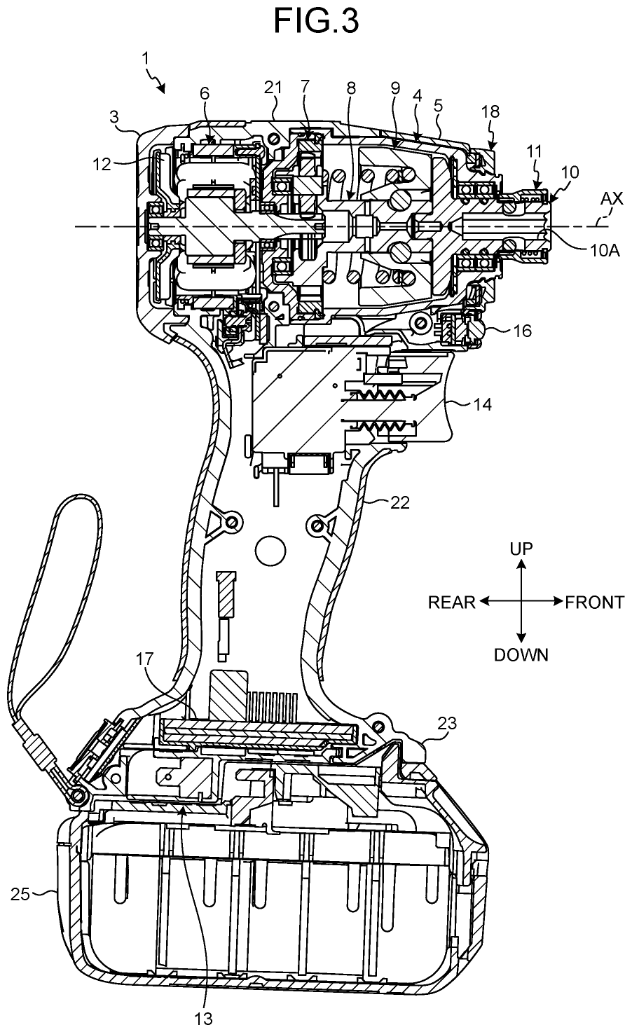

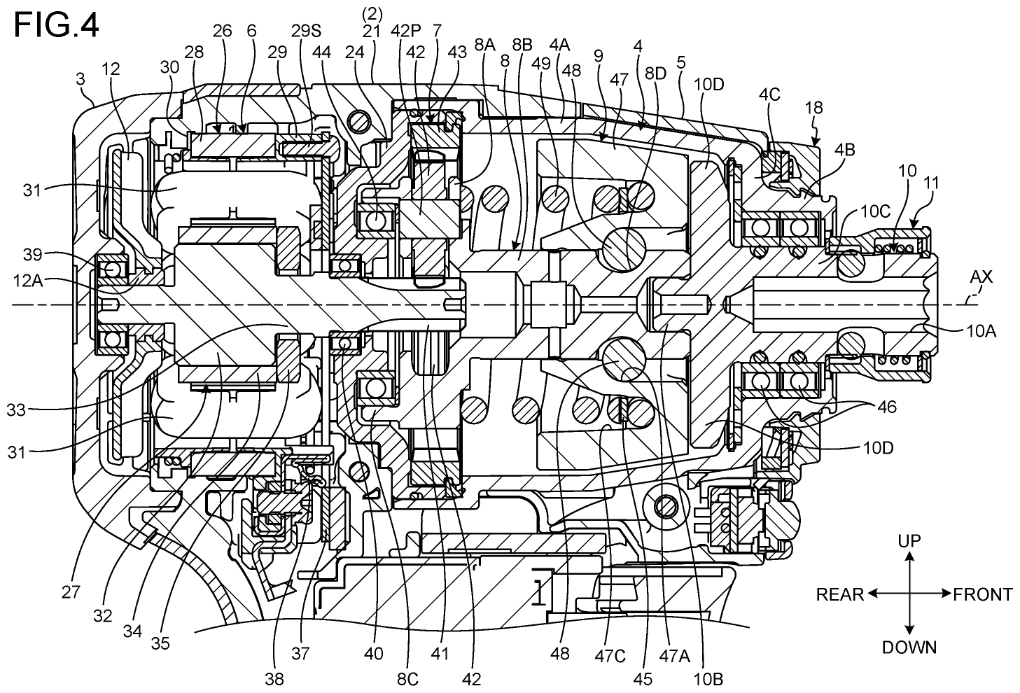

FIG. 1 is an oblieque view, viewed from the front, which illustrates a power tool 1 according to the present embodiment. FIG. 2 is a side view illustrating the power tool 1 according to the present embodiment. FIG. 3 is a cross-sectional view illustrating the power tool 1 according to the present embodiment. FIG. 4 is a cross-sectional view illustrating an upper portion of the power tool 1 according to the present embodiment.

In the present embodiment, the power tool 1 is a power tool having an electric motor 6 as a power source. A direction parallel to a rotation axis AX of the motor 6 is appropriately referred to as an axial direction, a direction around the rotation axis AX is appropriately referred to as a circumferential direction or a rotation direction, and a radial direction of the rotation axis AX is appropriately referred to as a radial direction. In the radial direction, a position close to or a direction approaching the rotation axis AX is appropriately referred to as radially inward, and a position far from or a direction away from the rotation axis AX is appropriately referred to as radially outward. In the present embodiment, the rotation axis AX extends in a front-rear direction. One side in the axial direction is a front side, and the other side in the axial direction is a rear side.

In the present embodiment, the power tool 1 is assumed to be an impact tool which is a type of power tool. In the following description, the power tool 1 is appropriately referred to as an impact tool 1.

In the present embodiment, the impact tool 1 is an impact driver which is a type of screw fastening tool. The impact tool 1 includes a housing 2, a rear cover 3, a hammer case 4, a case cover 5, the motor 6, a speed reduction mechanism 7, a spindle 8, an impact mechanism 9, an anvil 10, a tool holding mechanism 11, a fan 12, a battery mounting unit 13, a trigger lever 14, a forward/reverse switching lever 15, a hand mode switching button 16, a controller 17, and a light unit 18.

The housing 2 is made of synthetic resin. In the present embodiment, the housing 2 is made of nylon. The housing 2 includes a left housing 2L and a right housing 2R disposed on a right side of the left housing 2L. The left housing 2L and the right housing 2R are fixed by a plurality of screws 2S. The housing 2 includes a pair of half-split housings.

The housing 2 includes a motor housing portion 21, a grip portion 22, and a battery holder 23.

The motor housing portion 21 has a cylindrical shape. The motor housing portion 21 houses therein the motor 6, a part of a bearing box 24, and a rear portion of the hammer case 4.

The grip portion 22 protrudes downward from the motor housing portion 21. The trigger lever 14 is provided above the grip portion 22. The grip portion 22 is held by an operator.

The battery holder 23 is connected to a lower end portion of the grip portion 22. In each of the front-rear direction and the left-right direction, an outer dimension of the battery holder 23 is larger than an outer dimension of the grip portion 22.

The rear cover 3 is made of synthetic resin. The rear cover 3 is disposed rearward of the motor housing portion 21. The rear cover 3 houses at least a part of the fan 12. The fan 12 is disposed on an inner-circumference side of the rear cover 3. The rear cover 3 is disposed such that it covers an opening in a rear end portion of the motor housing portion 21.

The motor housing portion 21 has air-intake ports 19. The rear cover 3 has air-exhaust ports 20. Air from outside of the housing 2 flows into an interior space of the housing 2 via the air-intake ports 19. Air from the interior space of the housing 2 flows out to the outside of the housing 2 via the air-exhaust ports 20.

The hammer case 4 functions as a gear case that accommodates therein the speed reduction mechanism 7. The hammer case 4 accommodates therein at least a part of the speed reduction mechanism 7, the spindle 8, the impact mechanism 9, and the anvil 10. The hammer case 4 is made of a metal. In the present embodiment, the hammer case 4 is made of aluminum. The hammer case 4 has a cylindrical shape.

The hammer case 4 includes a rear cylindrical portion 4A, a front cylindrical portion 4B, and an annular portion 4C. The front cylindrical portion 4B is disposed in front of the rear cylindrical portion 4A. An outer diameter of the rear cylindrical portion 4A is larger than an outer diameter of the front cylindrical portion 4B. An inner diameter of the rear cylindrical portion 4A is larger than an inner diameter of the front cylindrical portion 4B. The annular portion 4C is disposed so as to connect a front end portion of the rear cylindrical portion 4A and a rear end portion of the front cylindrical portion 4B.

The hammer case 4 is connected to a front portion of the motor housing portion 21. The bearing box 24 is fixed to a rear portion of the rear cylindrical portion 4A. At least a part of the speed reduction mechanism 7 is disposed inside the bearing box 24. A screw thread is formed on an outer-circumferential portion of the bearing box 24. A screw groove is formed in an inner-circumferential portion of the rear portion of the rear cylindrical portion 4A. The bearing box 24 and the hammer case 4 are fixed by coupling the screw thread of the bearing box 24 and the screw groove of the rear cylindrical portion 4A. The hammer case 4 is sandwiched between the left housing 2L and the right housing 2R. A part of the bearing box 24 and the rear portion of the rear cylindrical portion 4A are housed in the motor housing portion 21. The bearing box 24 is fixed to each of the motor housing portion 21 and the hammer case 4.

The case cover 5 covers at least a part of a surface of the hammer case 4. In the present embodiment, the case cover 5 covers a surface of the rear cylindrical portion 4A. The case cover 5 is made of synthetic resin. In the present embodiment, the case cover 5 is made of polycarbonate resin. The case cover 5 protects the hammer case 4. The case cover 5 blocks contact between the hammer case 4 and an object around the impact tool 1. The case cover 5 blocks contact between the hammer case 4 and the operator.

The motor 6 is a power source of the impact tool 1. The motor 6 generates a rotational force. The motor 6 is an electric motor. The motor 6 is an inner-rotor-type brushless motor. The motor 6 includes a stator 26 and a rotor 27. The stator 26 is supported by the motor housing portion 21. At least a part of the rotor 27 is disposed inside the stator 26. The rotor 27 rotates relative to the stator 26. The rotor 27 rotates about the rotation axis AX extending in the front-rear direction.

The stator 26 includes a stator core 28, a front insulator 29, a rear insulator 30, and coils 31.

The stator core 28 is disposed radially outside with respect to the rotor 27. The stator core 28 includes a plurality of laminated steel plates. The steel plates are plates made of a metal containing iron as a main component. The stator core 28 has cylindrical shape. The stator core 28 includes teeth that respectively support the coils 31.

The front insulator 29 is provided at a front portion of the stator core 28. The rear insulator 30 is provided at a rear portion of the stator core 28. The front insulator 29 and the rear insulator 30 each are an electrically insulating member made of a synthetic resin. The front insulator 29 is disposed so as to cover some of the teeth surfaces. The rear insulator 30 is disposed so as to cover some of the teeth surfaces.

The coils 31 are mounted on the stator core 28 via the front insulator 29 and the rear insulator 30. The coils 31 are disposed around the teeth of the stator core 28 via the front insulator 29 and the rear insulator 30. The coils 31 and the stator core 28 are electrically insulated from one another by the front insulator 29 and the rear insulator 30. The coils 31 are electrically connected via a fusing terminal 38.

The rotor 27 rotates about the rotation axis AX. The rotor 27 includes a rotor core portion 32, a rotor shaft portion 33, at least one rotor magnet 34, and at least one sensor magnet 35.

The rotor core portion 32 and the rotor shaft portion 33 each are made of steel. In the present embodiment, the rotor core portion 32 and the rotor shaft portion 33 are integrated. A front portion of the rotor shaft portion 33 protrudes forward from a front end surface of the rotor core portion 32. A rear portion of the rotor shaft portion 33 protrudes rearward from a rear end surface of the rotor core portion 32.

The rotor magnet 34 is fixed to the rotor core portion 32. The rotor magnet 34 has a cylindrical shape. The rotor magnet 34 is disposed around the rotor core portion 32.

The sensor magnet 35 is fixed to the rotor core portion 32. The sensor magnet 35 has a circular ring shape. The sensor magnet 35 is disposed on the front end surface of the rotor core portion 32 and the front end surface of the rotor magnet 34.

A sensor substrate 37 is mounted on the front insulator 29. The sensor substrate 37 is fixed to the front insulator 29 by at least one screw 29S. The sensor substrate 37 includes a circular circuit board and a magnetic sensor supported by the circuit board. At least a part of the sensor substrate 37 faces the sensor magnet 35. The magnetic sensor detects a position of the sensor magnet 35 to detect a position of the rotor 27 in the rotation direction.

The rear portion of the rotor shaft portion 33 is rotatably supported by a rotor bearing 39. The front portion of the rotor shaft portion 33 is rotatably supported by a rotor bearing 40. The rotor bearing 39 is held by the rear cover 3. The rotor bearing 40 is held by the bearing box 24. The front end portion of the rotor shaft portion 33 is disposed in the interior space of the hammer case 4 through an opening of the bearing box 24.

A pinion gear 41 is provided at a front end portion of the rotor shaft portion 33. The pinion gear 41 is connected to at least a part of the speed reduction mechanism 7. The rotor shaft portion 33 is connected to the speed reduction mechanism 7 via the pinion gear 41.

The speed reduction mechanism 7 transmits a rotational force of the motor 6 to the spindle 8 and the anvil 10. The speed reduction mechanism 7 is accommodated in the rear cylindrical portion 4A of the hammer case 4. The speed reduction mechanism 7 includes a plurality of gears. The speed reduction mechanism 7 is disposed forward of the motor 6. The speed reduction mechanism 7 connects the rotor shaft portion 33 and the spindle 8. The gears of the speed reduction mechanism 7 are driven by the rotor 27. The speed reduction mechanism 7 transmits the rotation of the rotor 27 to the spindle 8. The speed reduction mechanism 7 causes the spindle 8 to rotate at a rotation speed that is lower than a rotation speed of the rotor shaft portion 33. The speed reduction mechanism 7 includes a planetary gear mechanism.

The speed reduction mechanism 7 includes a plurality of planetary gears 42 disposed around the pinion gear 41, and an internal gear 43 disposed around the plurality of planetary gears 42. The pinion gear 41, the planetary gears 42, and the internal gear 43 are each housed in the hammer case 4 and the bearing box 24. Each of the planetary gears 42 meshes with the pinion gear 41. The planetary gears 42 are rotatably supported on the spindle 8 via pins 42P. The spindle 8 is rotated by the planetary gears 42. The internal gear 43 has internal teeth, which mesh with the planetary gears 42. The internal gear 43 is fixed to the bearing box 24. The internal gear 43 is always non-rotatable relative to the bearing box 24.

When the rotor shaft portion 33 rotates in response to the driving of the motor 6, the pinion gear 41 rotates, and the planetary gears 42 revolve around the pinion gear 41. The planetary gears 42 revolve while meshing with the internal teeth of the internal gear 43. Owing to the revolving of the planetary gears 42, the spindle 8, which is connected to the planetary gears 42 via the pin 42P, rotates at a rotation speed that is lower than a rotation speed of the rotor shaft portion 33.

The spindle 8 is rotated by the rotational force of the motor 6. The spindle 8 is disposed forward of at least a part of the motor 6. The spindle 8 is disposed forward of the stator 26. At least a part of the spindle 8 is disposed forward of the rotor 27. At least a part of the spindle 8 is disposed forward of the speed reduction mechanism 7. The spindle 8 is rotated by the rotor 27. The spindle 8 is rotated by a rotational force of the rotor 27 transmitted by the speed reduction mechanism 7.

The spindle 8 includes a flange portion 8A and a spindle shaft portion 8B protruding forward from the flange portion 8A. The planetary gears 42 are rotatably supported by the flange portion 8A via the pins 42P. A rotation axis of the spindle 8 and the rotation axis AX of the motor 6 coincide with one another. The spindle 8 rotates about the rotation axis AX.

The spindle 8 is rotatably supported by a spindle bearing 44. The spindle bearing 44 is held by the bearing box 24. The spindle 8 has a circular ring portion 8C protruding rearward from a rear portion of the flange portion 8A. The spindle bearing 44 is disposed inside the circular ring portion 8C. In the present embodiment, an outer ring of the spindle bearing 44 is connected to the circular ring portion 8C, and an inner ring of the spindle bearing 44 is supported by the bearing box 24.

The impact mechanism 9 is driven by the motor 6. The rotational force of the motor 6 is transmitted to the impact mechanism 9 via the speed reduction mechanism 7 and the spindle 8. The impact mechanism 9 impacts the anvil 10 in the rotation direction owing to the rotational force of the spindle 8, which is rotated by the motor 6. The impact mechanism 9 includes a hammer 47, balls 48, and a coil spring 49. The impact mechanism 9 including the hammer 47 is housed in the hammer case 4.

The hammer 47 is disposed forward of the speed reduction mechanism 7. The hammer 47 is accommodated in the rear cylindrical portion 4A. The hammer 47 is disposed around the spindle shaft portion 8B. The hammer 47 is held by the spindle shaft portion 8B. The balls 48 are disposed between the spindle shaft portion 8B and the hammer 47. The coil spring 49 is supported by the flange portion 8A and the hammer 47.

The hammer 47 is rotated by the motor 6. The rotational force of the motor 6 is transmitted to the hammer 47 via the speed reduction mechanism 7 and the spindle 8. The hammer 47 is rotatable together with the spindle 8 owing to the rotational force of the spindle 8, which is rotated by the motor 6. A rotation axis of the hammer 47, the rotation axis of the spindle 8, and the rotation axis AX of the motor 6 coincide with one another. The hammer 47 rotates about the rotation axis AX.

The balls 48 are made of a metal such as steel. The balls 48 are disposed between the spindle shaft portion 8B and the hammer 47. The spindle 8 has a spindle groove 8D in which at least a part of the ball 48 is disposed. The spindle groove 8D is provided on a part of an outer surface of the spindle shaft portion 8B. The hammer 47 has a hammer groove 47A in which at least a part of the ball 48 is disposed. The hammer groove 47A is provided on a part of an inner surface of the hammer 47. The balls 48 are disposed between the spindle groove 8D and the hammer groove 47A. The balls 48 can roll along the inner side of the spindle groove 8D and the inner side of the hammer groove 47A. The hammer 47 is movable as the balls 48 roll. The spindle 8 and the hammer 47 can move relative to one another in the axial direction and the rotation direction within movable ranges defined by the spindle groove 8D and the hammer groove 47A.

The coil spring 49 generates an elastic (spring) force, which causes the hammer 47 to move forward. The coil spring 49 is disposed between the flange portion 8A and the hammer 47. A ring-shaped recess 47C is provided on a rear surface of the hammer 47. The recess 47C is recessed forward from the rear surface of the hammer 47. A washer 45 is provided on an inner side of the recess 47C. A rear end portion of the coil spring 49 is supported by the flange portion 8A. A front end portion of the coil spring 49 is disposed on the inner side of the recess 47C and is supported by the washer 45.

The anvil 10 is an output shaft of the impact tool 1 that rotates by the rotational force of the motor 6. At least a part of the anvil 10 is disposed forward of the hammer 47. The anvil 10 has a tool (bit) hole 10A into which a tool accessory, e.g., a bit, is inserted. The tool hole 10A is provided at a front end portion of the anvil 10. The tool accessory is mounted on the anvil 10. Furthermore, a protrusion 10B is provided at a rear end portion of the anvil 10. A recess is provided at a front end portion of the spindle shaft portion 8B. The protrusion 10B is inserted into the recess provided at the front end portion of the spindle shaft portion 8B.

The anvil 10 includes a rod-shaped anvil shaft portion 10C and an anvil projection 10D. The tool hole 10A is provided in a front end portion of the anvil shaft portion 10C. The tool accessory is mounted in (on) the anvil shaft portion 10C. The anvil projection 10D is provided at a rear end portion of the anvil 10. The anvil projection 10D projects radially outward from a rear end portion of the anvil shaft portion 10C.

The anvil 10 is rotatably supported by an anvil bearings 46. A rotation axis of the anvil 10, the rotation axis of the hammer 47, the rotation axis of the spindle 8, and the rotation axis AX of the motor 6 coincide with one another. The anvil 10 rotates about the rotation axis AX. The anvil bearings 46 are disposed in the interior of the front cylindrical portion 4B. The anvil bearings 46 are held by the front cylindrical portion 4B of the hammer case 4. The anvil bearings 46 support the anvil shaft portion 10C. In the present embodiment, two anvil bearings 46 are disposed in the front-rear direction.

At least a part of the hammer 47 is capable of coming into contact with the anvil projection 10D. A hammer projection projecting forward is provided at a front portion of the hammer 47. The hammer projection of the hammer 47 and the anvil projection 10D are capable of coming into contact with one another. When the motor 6 is driven (supplied with current) in a state where the hammer 47 and the anvil projection 10D are in contact with one another, the anvil 10 rotates together with the hammer 47 and the spindle 8.

The anvil 10 is impactable (strikable) in the rotation direction by the hammer 47. For example, during screw-fastening work, there are situations in which, when a load that acts on the anvil 10 becomes high, the anvil 10 can no longer be caused to rotate merely by the power generated by the motor. When the anvil 10 can no longer be caused to rotate merely by the power generated by the motor 6, the rotation of the anvil 10 and the hammer 47 will (temporarily) stop. As a result, the spindle 8 and the hammer 47 will move relative to one another in the axial direction and the circumferential direction via the balls 48. That is, even when the rotation of the hammer 47 (temporarily) stops, the rotation of the spindle 8 continues owing to the power generated by the motor 6. In the state where the rotation of the hammer 47 has stopped, when the spindle 8 rotates relative to the hammer 47, the balls 48 move rearward while being guided by the spindle groove 8D and the hammer groove 47A. The hammer 47 receives a force from the balls 48 and moves rearward along with the balls 48. That is, in a state where the rotation of the anvil 10 is stopped, the hammer 47 moves rearward in response to the rotation of the spindle 8. The contact between the hammer 47 and the anvil projection 10D is released by the movement of the hammer 47 rearward.

The coil spring 49 generates an elastic (spring) force, which causes the hammer 47 to move forward. The hammer 47, which had previously moved rearward, now moves forward owing to the elastic force of the coil spring 49. When the hammer moves forward, the hammer 47 receives a force in the rotation direction from the balls 48. That is, the hammer 47 moves forward while rotating. When the hammer 47 moves forward while rotating, the hammer 47 comes into contact with the anvil projection 10D while rotating. As a result, the anvil projection 10D is impacted in the rotation direction by the hammer 47. Both the power of the motor 6 and the inertial force of the hammer 47 act on the anvil 10. Therefore, the anvil 10 can be rotated about the rotation axis AX with a high torque.

The tool holding mechanism 11 is disposed around the front portion of the anvil 10. The tool holding mechanism 11 holds the tool accessory, which is inserted into the tool hole 10A.

The fan 12 is rotated by the rotational force of the motor 6. The fan 12 is disposed rearward of the stator 26 of the motor 6. The fan 12 generates an airflow for cooling the motor 6. The fan 12 is fixed to at least a part of the rotor 27. The fan 12 is fixed to the rear portion of the rotor shaft portion 33 via a bush 12A. The fan 12 is disposed between the rotor bearing 39 and the stator 26. The fan 12 rotates when the rotor 27 rotates. When the rotor shaft portion 33 rotates, the fan 12 rotates together with the rotor shaft portion 33. When the fan 12 rotates, air from outside of the housing 2 flows into the interior space of the housing 2 through the air-intake ports 19. The air that has flowed into the interior space of the housing 2 flows through the interior space of the housing 2, thereby cooling the motor 6. The air that has flowed through the interior space of the housing 2 flows out to the outside of the housing 2 via the air-exhaust ports 20 while the fan 12 is rotating.

The battery mounting unit 13 is disposed at a lower portion of the battery holder 23. The battery mounting unit 13 is connected to a battery pack 25. The battery pack 25 is mounted on the battery mounting unit 13. The battery pack 25 is detachable from the battery mounting unit 13. The battery pack 25 functions as a power supply of the impact tool 1. The battery pack 25 includes one or more secondary batteries. In the present embodiment, the battery pack 25 includes one or more rechargeable lithium-ion batteries. After being mounted on the battery mounting unit 13, the battery pack 25 can supply electric power to the impact tool 1. The motor 6 and the light unit 18 is driven based on the electric power (current) supplied from the battery pack 25.

The trigger lever 14 is provided on the grip portion 22. The trigger lever 14 is operated by an operator to start the motor 6. The motor 6 is changed between driving and stoppage in response to operation of the trigger lever 14.

The forward/reverse switching lever 15 is provided at an upper portion of the grip portion 22. The forward/reverse switching lever 15 is operated by an operator. In response to the operation of the forward/reverse switching lever 15, the rotation direction of the motor 6 is changed from one of a forward-rotational direction and a reverse-rotational direction to the other. When the rotation direction of the motor 6 is changed, the rotational direction of the spindle 8 is changed.

The hand mode switching button 16 is provided at an upper portion of the trigger lever 14. The hand mode switching button 16 can be operated (pressed) by an operator. A control mode of the motor 6 is changed in response to the operation of the hand mode switching button 16.

The controller 17 outputs control signals, which control at least the motor 6 and the light unit 18. The controller 17 is accommodated in the battery holder 23. The controller 17 changes the control mode of the motor 6 based on the work content required to be performed by the impact tool 1. The control mode of the motor 6 refers to a control method or a control pattern of the motor 6. The controller 17 includes a circuit board on which a plurality of electronic components are mounted. Examples of the electronic components mounted on the circuit board include: a processor such as a central processing unit (CPU); nonvolatile memory such as a read only memory (ROM) or storage; volatile memory such as a random access memory (RAM); transistors, and resistors.

Light Unit

The light unit 18 emits illumination light. The light unit 18 illuminates the anvil 10 and the periphery of the anvil 10 with illumination light. The light unit 18 illuminates the front of the anvil 10 with illumination light. Furthermore, the light unit 18 illuminates the tool accessory attached to the anvil 10 and the periphery of the tool accessory with illumination light.

The light unit 18 is disposed at the front portion of the hammer case 4. The light unit 18 is disposed around the front cylindrical portion 4B.

The light unit 18 includes a chip-on-board light emitting diode (COB LED).

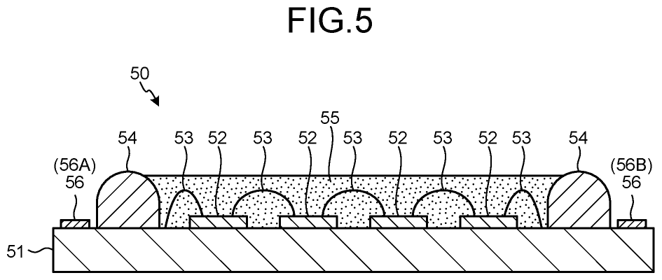

FIG. 5 is a diagram schematically illustrating a chip-on-board light emitting diode 50 according to the present embodiment. The chip-on-board light emitting diode 50 includes a substrate 51, LED chips 52, gold wires 53, a bank 54, a phosphor (phosphor coating) 55, and a pair of electrodes 56. Examples of the substrate 51 include: an aluminum substrate, a woven fiberglass reinforced epoxy substrate (FR-4 substrate), and a composite epoxy material substrate (CEM-3 substrate). The LED chips 52 are mounted on a surface of the substrate 51. The gold wires 53 connect the LED chips 52 and the substrate 51. The gold wires 53 connect the LED chips 52 to one another. The bank 54 is provided on the surface of the substrate 51. The bank 54 is disposed around the LED chips 52. The bank 54 defines a compartment space in which the phosphor 55 is disposed. The phosphor 55 is disposed on the inner side of the bank 54 so as to cover the LED chips 52. Each of the electrodes 56 is disposed on the surface of the substrate 51 on the outer side of the bank 54. The electrodes 56 may be disposed on a back surface of the substrate 51. Among the electrodes 56, one electrode 56 is a positive electrode 56A, and the other electrode 56 is a negative electrode 56B. The electrodes 56 are connected to the battery pack 25 via the controller 17 and lead wires. The power output from the battery pack 25 is supplied to the electrodes 56 via the controller 17 and the lead wires. The power supplied to the electrodes 56 is supplied to the LED chips 52 via the substrate 51 and the gold wires 53. The LED chips 52 emit light owing to the power supplied from the battery pack 25. A voltage, which has been stepped down to 5 V by the controller 17, of the battery pack 25 is applied to the LED chips 52.

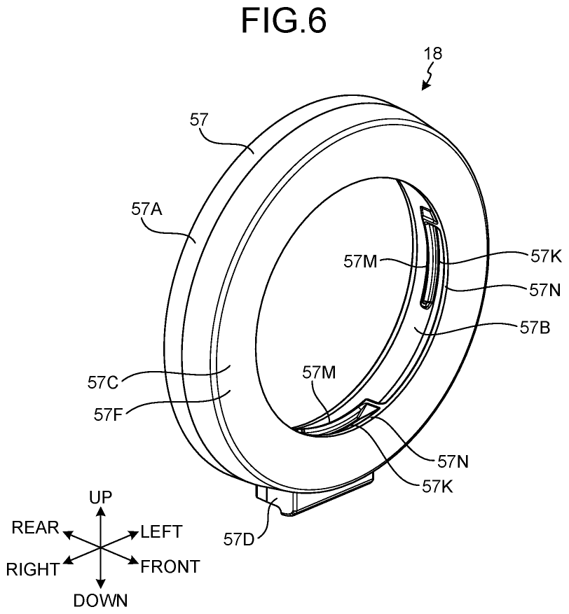

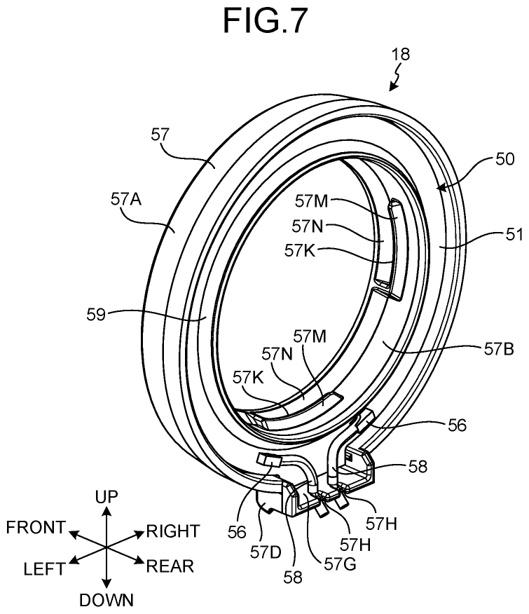

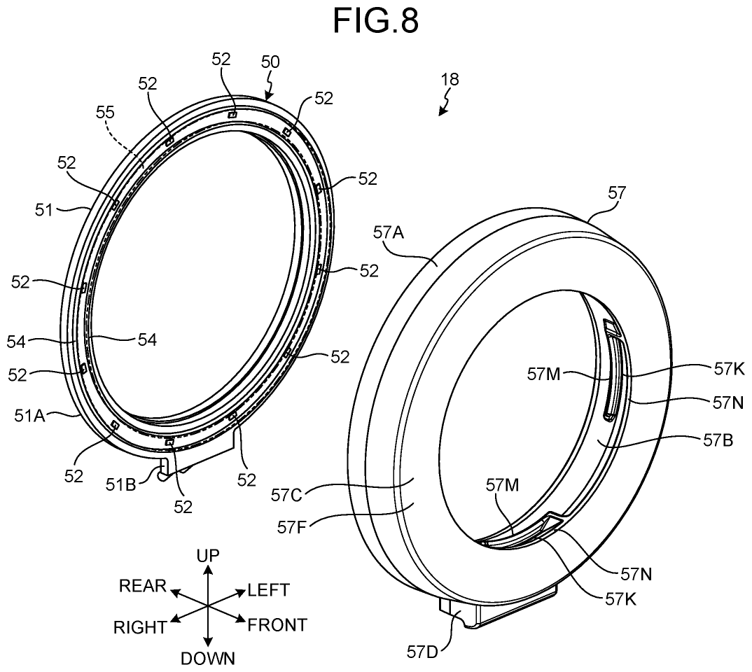

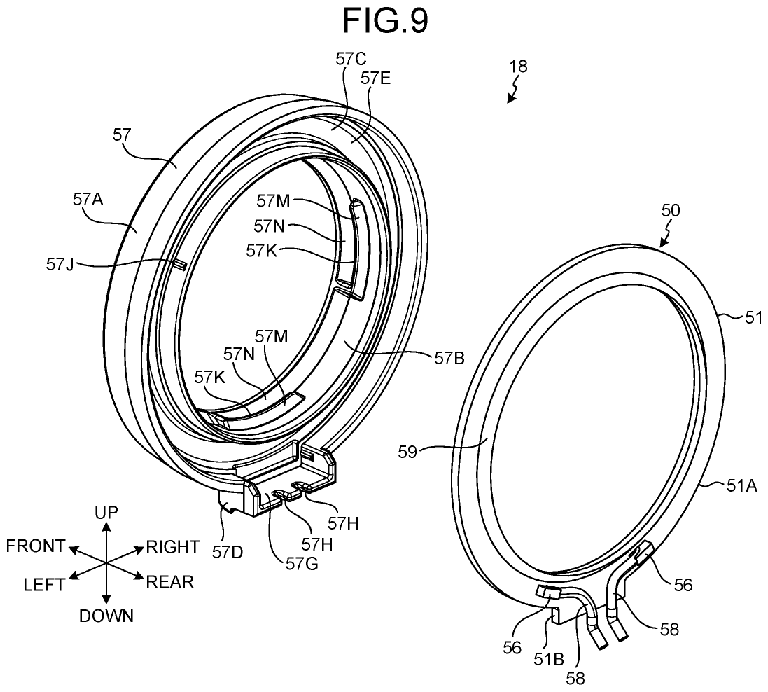

FIG. 6 is an oblique view, viewed from the front, which illustrates the light unit 18 according to the present embodiment. FIG. 7 is an oblique view, viewed from the rear, which illustrates the light unit 18 according to the present embodiment. FIG. 8 is an exploded oblique view, viewed from the front, which illustrates the light unit 18 according to the present embodiment. FIG. 9 is an exploded oblique view, viewed from the rear, which illustrates the light unit 18 according to the present embodiment.

As illustrated in FIGS. 6, 7, 8, and 9, the light unit 18 includes the chip-on-board light emitting diode 50 and a light cover 57. The chip-on-board light emitting diode 50 includes the substrate 51, the plurality of LED chips 52, the bank 54, the phosphor 55, and the pair of electrodes 56.

The substrate 51 has an annular shape. The substrate 51 includes a circular ring portion 51A and a support portion 51B protruding downward from a lower portion of the circular ring portion 51A.

The LED chips 52 are arranged on a front surface of the circular ring portion 51A of the substrate 51. The LED chips 52 are arranged at intervals in a circumferential direction of the circular ring portion 51A. In the present embodiment, 12 LED chips 52 are arranged at equal intervals in the circumferential direction of the circular ring portion 51A.

In the present embodiment, the number of the LED chips 52 is 12, but may be more than 12, for example, 24 or 36. The number of LED chips 52 may be a multiple of 6.

The bank 54 is provided on the front surface of the circular ring portion 51A of the substrate 51. The bank 54 protrudes forward from the front surface of the circular ring portion 51A. The bank 54 has a circular ring shape. In the present embodiment, the bank 54 is provided in a double circular ring shape as illustrated in FIG. 8. That is, in the present embodiment, the bank 54 includes a first bank 54 and a second bank 54 disposed radially outside with respect to the first bank 54. The first bank 54 is disposed radially inside with respect to the LED chips 52. The second bank 54 is disposed radially outside with respect to the LED chips 52.

The phosphor 55 is disposed on the front surface of the circular ring portion 51A of the substrate 51. The phosphor 55 has a circular ring shape. The phosphor 55 is disposed between the first bank 54 and the second bank 54. The phosphor 55 is disposed so as to cover the LED chips 52.

In the present embodiment, the electrodes 56 are disposed on the rear surface of the substrate 51. In the present embodiment, the electrodes 56 are disposed on the rear surface of the circular ring portion 51A. The electrodes 56 are connected to the controller 17 via a lead wires 58. Each of the lead wires 58 is connected to a corresponding one of the electrodes 56. A pair of the lead wires 58 is supported on a rear surface of the support portion 51B. The electrodes 56 may be disposed on a front surface of the support portion 51B, for example. The lead wires 58 may be supported on the front surface of the support portion 51B.

A current output from the battery pack 25 is supplied to the electrodes 56 via the controller 17 and the lead wires 58. The current supplied to the electrodes 56 is supplied to the LED chips 52 via the substrate 51 and the gold wires 53 (not illustrated in FIGS. 6 to 9). The LED chips 52 emit light based on the current supplied from the battery pack 25.

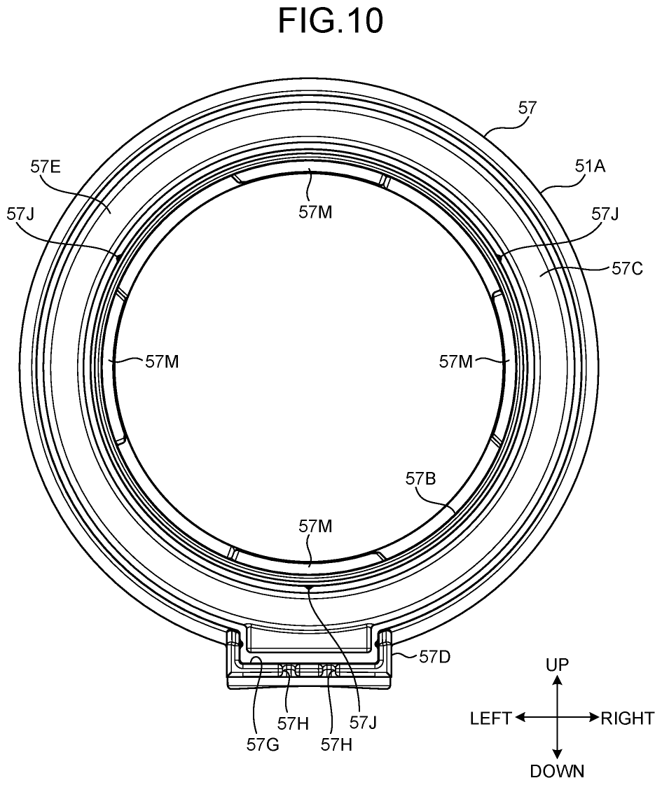

FIG. 10 is a rear view of the light cover 57 according to the present embodiment. The light cover 57 is connected to the chip-on-board light emitting diode 50. The light cover 57 is fixed to the substrate 51. The light cover 57 is made of polycarbonate resin. The light cover 57 is transparent. Alternatively, the light cover 57 may be a thin white translucent light cover. At least a part of the light cover 57 is disposed in front of the chip-on-board light emitting diode 50. The light cover 57 includes an outer cylindrical portion 57A, an inner cylindrical portion 57B, a light transmission portion 57C, and a support portion 57D.

The outer cylindrical portion 57A is disposed radially outside with respect to the inner cylindrical portion 57B. In the radial direction, at least a part of the chip-on-board light emitting diode 50 is disposed between the outer cylindrical portion 57A and the inner cylindrical portion 57B. The outer cylindrical portion 57A is disposed radially outside with respect to the circular ring portion 51A of the substrate 51. The inner cylindrical portion 57B is disposed radially inside with respect to the circular ring portion 51A of the substrate 51.

The light transmission portion 57C has a circular ring shape. The light transmission portion 57C is disposed so as to connect a front end portion of the outer cylindrical portion 57A and a front end portion of the inner cylindrical portion 57B. The light transmission portion 57C faces the front surface of the circular ring portion 51A. The light transmission portion 57C faces the LED chips 52. The light emitted from the LED chips 52 passes through the light transmission portion 57C and is emitted forward from the light unit 18.

The light transmission portion 57C has an entrance surface 57E on which the light from the LED chips 52 is incident, and an exit surface 57F from which the light transmitted through the light transmission portion 57C is output. The entrance surface 57E faces the LED chips 52. The entrance surface 57E faces substantially rearward. The exit surface 57F faces substantially forward.

The support portion 57D is provided so as to protrude downward from a lower portion of the outer cylindrical portion 57A. A recess 57G is formed in the support portion 57D. The support portion 51B of the substrate 51 is disposed in the recess 57G. Two notches 57H are formed in the support portion 57D. The lead wires 58 are respectively disposed in the notches 57H.

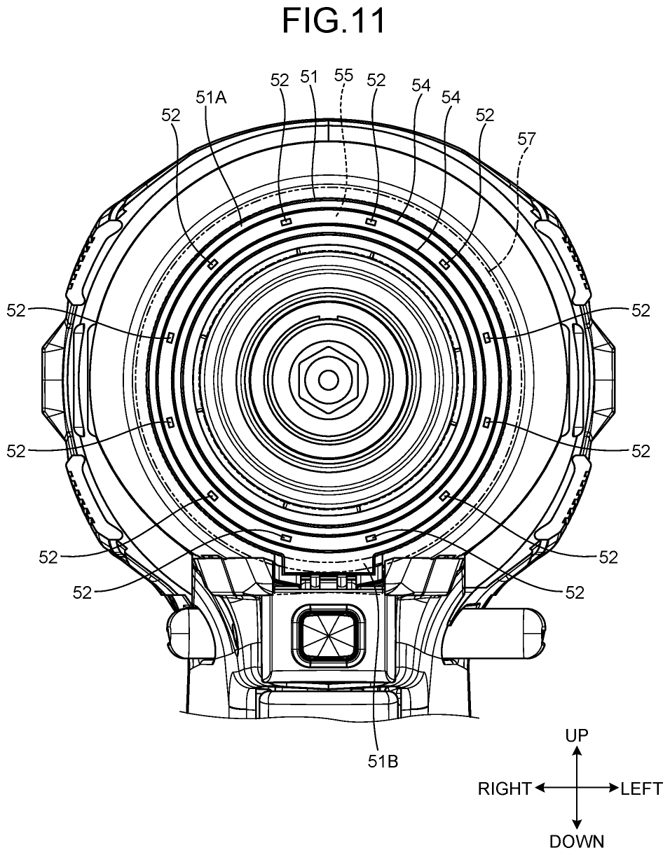

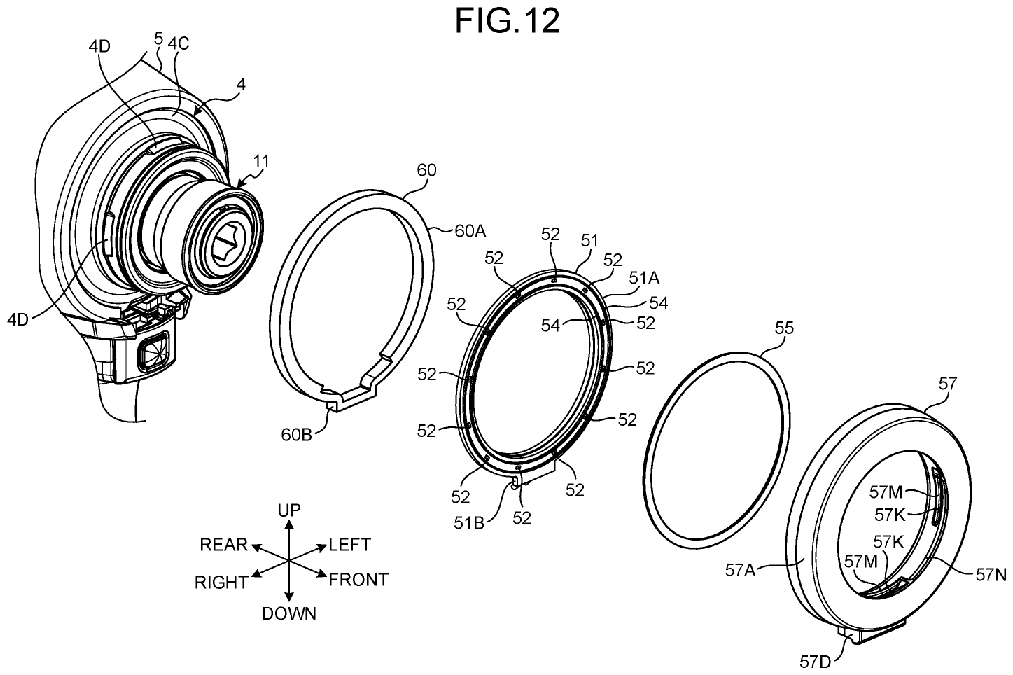

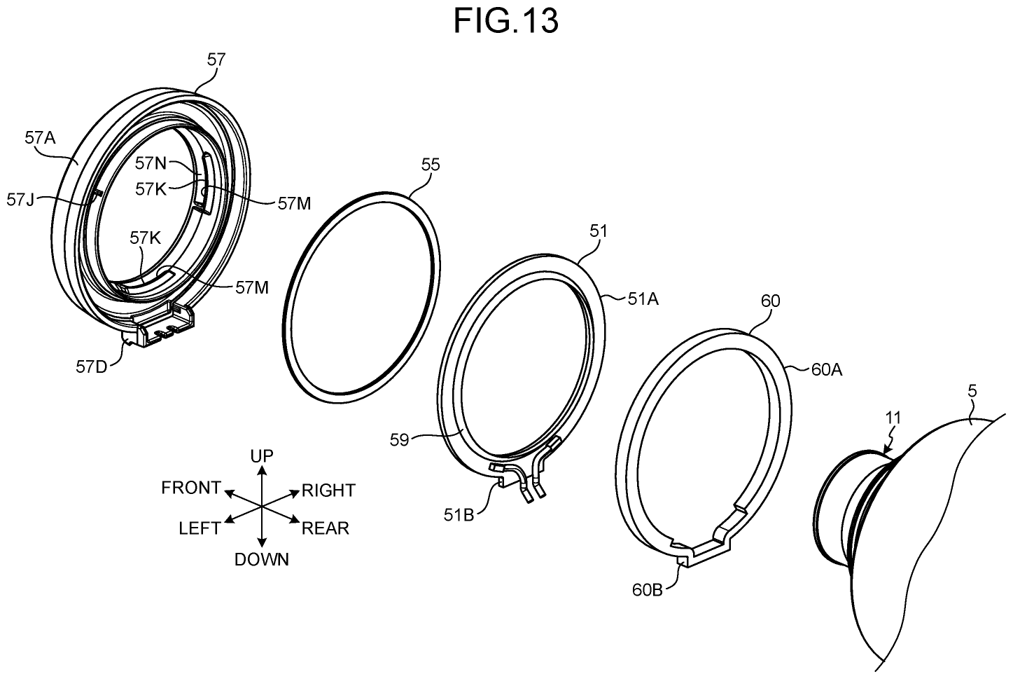

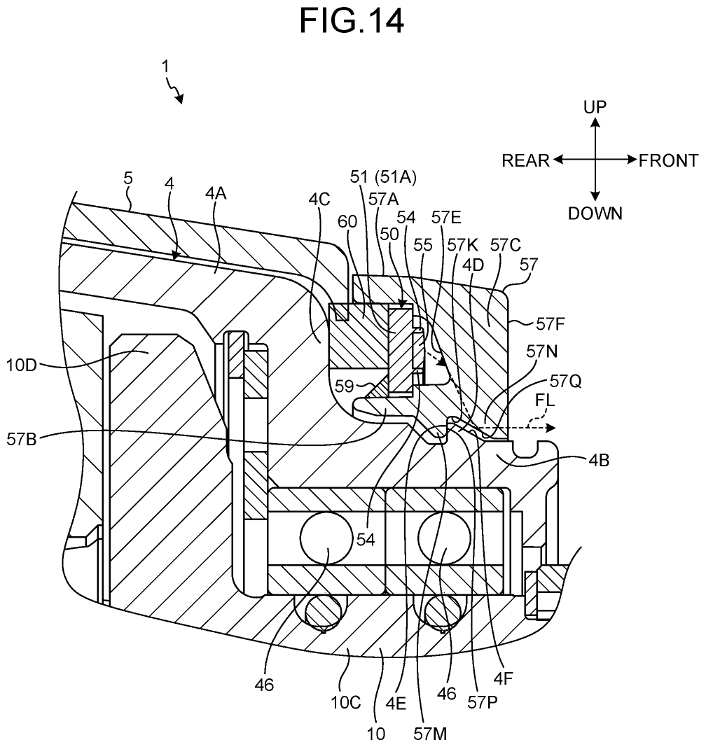

FIG. 11 is a front view of the upper portion of the power tool 1 according to the present embodiment. FIG. 12 is an exploded oblique view, viewed from the front, which illustrates the upper portion of the power tool 1 according to the present embodiment. FIG. 13 is an exploded oblique view, viewed from the rear, which illustrates the upper portion of the power tool 1 according to the present embodiment. FIG. 14 is a cross-sectional view illustrating a part of the power tool 1 according to the present embodiment.

The light unit 18 including the chip-on-board light emitting diode 50 is disposed around the anvil shaft portion 10C of the anvil 10. The light unit 18 including the chip-on-board light emitting diode 50 is disposed around the front cylindrical portion 4B of the hammer case 4. The inner cylindrical portion 57B of the light cover 57 is disposed around the front cylindrical portion 4B of the hammer case 4. The inner cylindrical portion 57B of the light cover 57 is fixed to the front cylindrical portion 4B of the hammer case 4.

The substrate 51 is fixed to the light cover 57. In the radial direction, the substrate 51 is disposed between the outer cylindrical portion 57A and the inner cylindrical portion 57B. As illustrated in FIGS. 9 and 10, support protrusions 57J are provided on an outer circumferential surface of the inner cylindrical portion 57B. The support protrusions 57J protrude radially outward from the outer circumferential surface of the inner cylindrical portion 57B. The support protrusions 57J are provided at intervals in the circumferential direction. As illustrated in FIG. 10, in the present embodiment, three support protrusions 57J are provided at intervals in the circumferential direction. An inner circumferential surface of the circular ring portion 51A of the substrate 51 is supported by the support protrusions 57J. The substrate 51 is fixed to the inner cylindrical portion 57B via an adhesive 59 (FIG. 7). In the present embodiment, the rear surface of the substrate 51 and the outer circumferential surface of the inner cylindrical portion 57B are fixed by the adhesive 59.

Protrusions 4D are provided on the outer circumferential surface of the front cylindrical portion 4B. The protrusions 4D protrude radially outward from the outer circumferential surface of the front cylindrical portion 4B. The protrusions 4D are provided at intervals in the circumferential direction. In the present embodiment, four protrusions 4D are provided at intervals in the circumferential direction. Each of the protrusions 4D has a rear surface 4E facing rearward and a slope 4F inclined radially inward toward the front.

The light cover 57 is fixed to the front cylindrical portion 4B of the hammer case 4. On an inner-circumferential surface of the inner cylindrical portion 57B of the light cover 57, rear slide portions 57M and front slide portions 57N are provided. The rear slide portions 57M and the front slide portions 57N each protrude radially inward from the inner-circumferential surface of the inner cylindrical portion 57B. The front slide portions 57N are disposed forward of the rear slide portions 57M. As illustrated in FIG. 10, four rear slide portions 57M are provided at intervals in the circumferential direction. The four front slide portions 57N are respectively disposed forward of the four rear slide portions 57M. Recesses 57K are provided between the rear slide portions 57M and the front slide portions 57N. The protrusions 4D are respectively disposed in the recesses 57K. The rear slide portions 57M each have a front surface 57P, which is in contact with the rear surface 4E of each of the protrusions 4D. The front slide portions 57N each have a slope 57Q, which faces the slope 4F of each of the protrusions 4D.

An insertion port is provided between one end of each of the rear slide portions 57M in the circumferential direction and the corresponding one of the front slide portions 57N. The protrusions 4D are disposed in the recesses 57K via the insertion ports. After the protrusions 4D are inserted into the insertion ports, the light unit 18 is rotated, whereby the protrusions 4D are inserted into the recesses 57K. As a result, the light cover 57 and the front cylindrical portion 4B of the hammer case 4 are fixed. The light unit 18 and the hammer case 4 are fixed by fixing the light cover 57 and the front cylindrical portion 4B of the hammer case 4.

The light emitted from the LED chips 52 is incident on the entrance surface 57E via the phosphor 55. As illustrated in FIG. 14, the entrance surface 57E is inclined forward toward the radial inside. The light incident on the entrance surface 57E passes through the light transmission portion 57C and then is output through the exit surface 57F.

As indicated by an arrow FL in FIG. 14, at least a part of the light incident on the entrance surface 57E reaches the slopes 57Q. Each of the slopes 57Q is inclined forward toward the radial inside. The light that has reached each of the slopes 57Q is totally reflected by the slope 57Q and travels forward. The light totally reflected by the slopes 57Q is output through the exit surface 57F.

In the present embodiment, the impact tool 1 includes a heat dissipation device that dissipates heat of the chip-on-board light emitting diode 50. The heat dissipation device includes a heat dissipation member to which heat of the chip-on-board light emitting diode 50 is transferred. In the present embodiment, the heat dissipation member includes the hammer case 4.

In the present embodiment, the heat of the chip-on-board light emitting diode 50 is transferred to the hammer case 4 via a thermal interface material (TIM) 60. The thermal interface material 60 is disposed between the hammer case 4 and the light unit 18. The thermal interface material 60 is in contact with the substrate 51 of the chip-on-board light emitting diode 50 and the hammer case 4.

In the present embodiment, the thermal interface material 60 is disposed between the rear surface of the substrate 51 and the front surface of the annular portion 4C. The thermal interface material 60 is in contact with the rear surface of the substrate 51 and the front surface of the annular portion 4C. The thermal conductivity of the thermal interface material 60 is higher than the thermal conductivity of air. The thermal conductivity of the thermal interface material 60 is higher than the thermal conductivity of the substrate 51. The thermal conductivity of the thermal interface material 60 is higher than the thermal conductivity of the light cover 57. The thermal interface material 60 is an electrically insulating material.

The thermal interface material 60 may be a coating film applied to one or both of the substrate 51 and the hammer case 4, or may have a solid sheet shape. In the present embodiment, the thermal interface material 60 is a solid sheet-like member. In the following description, the thermal interface material 60 is appropriately referred to as a thermal interface sheet 60.

The thermal interface sheet 60 has an annular shape. The thermal interface sheet 60 includes: a circular ring portion 60A in contact with the rear surface of the circular ring portion 51A of the substrate 51; and a protrusion 60B which is in contact with the rear surface of the support portion 51B of the substrate 51. The protrusion 60B protrudes downward from a lower portion of the circular ring portion 60A.

When the trigger lever 14 is operated, the motor 6 is activated (energized), and light is emitted from the LED chips 52 of the chip-on-board light emitting diode 50. The chip-on-board light emitting diode 5 emits (outputs) a higher amount of light, thereby brightly illuminating the work target or work space.

On the other hand, the chip-on-board light emitting diode 50 generates a higher amount of heat, the temperature of the chip-on-board light emitting diode 50 may rise excessively. When the temperature of the chip-on-board light emitting diode 50 exceeds an allowable value, the LED chips 52 may deteriorate and the life of the chip-on-board light emitting diode 50 may be shortened. The allowable value of the temperature of the chip-on-board light emitting diode 50 is, for example, a heat resistant temperature of the LED chips 52.

A component, which generates the most heat, of the chip-on-board light emitting diode 50 is the LED chips 52. Each of the LED chips 52 is disposed in a space surrounded by the substrate 51 and the light cover 57. Heat of the LED chips 52 hardly escapes from a space surrounded by the substrate 51 and the light cover 57. In the present embodiment, the heat of the LED chips 52 is transferred to the hammer case 4 via the substrate 51 and the thermal interface sheet 60. The heat of the chip-on-board light emitting diode 50 transferred to the hammer case 4 is dissipated to the atmospheric space around the hammer case 4. As a result, an excessive rise in temperature of the chip-on-board light emitting diode 50 is suppressed.

The heat dissipation member may include the case cover 5. The thermal interface sheet 60 is in contact with the annular portion 4C of the hammer case 4 and the front end portion of the case cover 5. The heat of the chip-on-board light emitting diode 50 transferred to the case cover 5 is dissipated to the atmospheric space around the case cover 5.

The thermal interface sheet 60 may be disposed away from the case cover 5. The heat of the chip-on-board light emitting diode 50 transferred to the hammer case 4 via the thermal interface sheet 60 is dissipated to the atmospheric space around the case cover 5 via the case cover 5.

The heat dissipation member may include the light cover 57. The substrate 51 is in contact with at least one of the outer cylindrical portion 57A and the inner cylindrical portion 57B in a state of being spaced apart from the light transmission portion 57C. After the heat of the chip-on-board light emitting diode 50 is transferred to the light cover 57, it may be dissipated from the light cover 57 into the atmospheric space. The heat of the chip-on-board light emitting diode 50 may be transferred to the light cover 57 via the adhesive 59.

In the present embodiment, a drive voltage of the light unit 18 is 5 V. The light flux of the light unit 18 is 50 lumens or more and 200 lumens or less. The light flux of the light unit 18 may be 80 lumens or more and 150 lumens or less, or may be 100 lumens or more and 130 lumens or less.

Effects

As described above, in the present embodiment, the impact tool 1 may include: the motor 6; the anvil 10 that is rotated by the rotational force of the motor 6; the chip-on-board light emitting diode 50 disposed around the anvil 10; and the heat dissipation device that dissipates the heat of the chip-on-board light emitting diode 50.

According to the above configuration, since the heat of the chip-on-board light emitting diode 50 is dissipated by the heat dissipation device, an excessive rise in temperature of the chip-on-board light emitting diode 50 is suppressed.

In the present embodiment, the heat dissipation device may include a heat dissipation member to which heat of the chip-on-board light emitting diode 50 is transferred.

According to the above configuration, since the heat of the chip-on-board light emitting diode 50 is dissipated via the heat dissipation member, an excessive rise in temperature of the chip-on-board light emitting diode 50 is suppressed.

In the present embodiment, the impact tool 1 may include: the speed reduction mechanism 7 configured to transmit the rotational force of the motor 6 to the anvil 10; and the hammer case 4 that accommodates therein the speed reduction mechanism 7. The heat dissipation member may include the hammer case 4.

According to the above configuration, the heat of the chip-on-board light emitting diode 50 is dissipated through the hammer case 4.

In the present embodiment, the impact tool 1 may include the thermal interface material 60 that transfers heat of the chip-on-board light emitting diode 50 to the hammer case 4.

According to the above configuration, the heat of the chip-on-board light emitting diode 50 is efficiently transferred to the hammer case 4 via the thermal interface material 60.

In the present embodiment, the thermal interface material 60 may be in contact with the substrate 51 of the chip-on-board light emitting diode 50 and the hammer case 4.

According to the above configuration, the heat of the chip-on-board light emitting diode 50 is efficiently transferred to the hammer case 4 via the thermal interface material 60.

In the present embodiment, the thermal interface material 60 may have a sheet shape.

According to the above configuration, in a case where the thermal interface material 60 is the solid thermal interface sheet 60, the thermal interface sheet 60 can be sandwiched between the substrate 51 of the chip-on-board light emitting diode 50 and the hammer case 4.

In the present embodiment, the hammer case 4 may include: the rear cylindrical portion 4A that accommodates therein the speed reduction mechanism 7; the front cylindrical portion 4B that holds the anvil bearing 46 supporting the anvil 10; and an annular portion 4C that connects a front end portion of the rear cylindrical portion 4A and a rear end portion of the front cylindrical portion 4B. The chip-on-board light emitting diode 50 may be disposed around the front cylindrical portion 4B. The thermal interface material 60 may be in contact with each of the substrate 51 and the annular portion 4C.

According to the above configuration, an increase in size of the impact tool 1 is suppressed, and the heat of the chip-on-board light emitting diode 50 is efficiently transmitted to the annular portion 4C of the hammer case 4 via the thermal interface material 60.

In the present embodiment, the impact tool 1 may include a case cover 5 that covers the surface of the rear cylindrical portion 4A. The heat dissipation member may include the case cover 5. The thermal interface material 60 may be in contact with the case cover 5.

According to the above configuration, the heat of the chip-on-board light emitting diode 50 is efficiently dissipated through the case cover 5.

In the present embodiment, the substrate 51 may include the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respect to the circular ring portion 51A. The light transmission portion 57C may be disposed so as to connect the front end portion of the outer cylindrical portion 57A and the front end portion of the inner cylindrical portion 57B. The substrate 51 may be in contact with at least one of the outer cylindrical portion 57A and the inner cylindrical portion 57B in a state of being spaced apart from the light transmission portion 57C.

According to the above configuration, the heat of the chip-on-board light emitting diode 50 is efficiently transferred to the light cover 57.

In the present embodiment, the substrate 51 of the chip-on-board light emitting diode 50 may be fixed to the heat dissipation member via the adhesive 59. The heat of the chip-on-board light emitting diode 50 may be transferred to the heat dissipation member via the adhesive 59.

According to the above configuration, the heat of the chip-on-board light emitting diode 50 is efficiently transmitted to the heat dissipation member via the adhesive 59.

In the present embodiment, the impact tool 1 may include the light cover 57 including the light transmission portion 57C through which light emitted from the LED chip 52 of the chip-on-board light emitting diode 50 passes. The heat dissipation member may include the light cover 57.

According to the above configuration, the heat of the chip-on-board light emitting diode 50 is efficiently transferred to the light cover 57 via the adhesive 59.

In the present embodiment, the substrate 51 may include the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respet to the circular ring portion 51A. The light transmission portion 57C may be disposed so as to connect the front end portion of the outer cylindrical portion 57A and the front end portion of the inner cylindrical portion 57B. The substrate 51 may be fixed to the inner cylindrical portion 57B via the adhesive 59.

According to the above configuration, the heat of the chip-on-board light emitting diode 50 is efficiently transferred to the light cover 57 via the adhesive 59.

In the present embodiment, the hammer case 4 may include: the rear cylindrical portion 4A that accommodates therein the speed reduction mechanism 7; the front cylindrical portion 4B that holds the anvil bearing 46 supporting the anvil 10; and an annular portion 4C that connects a front end portion of the rear cylindrical portion 4A and a rear end portion of the front cylindrical portion 4B. The inner cylindrical portion 57B may be disposed around the front cylindrical portion 4B and may be fixed to the front cylindrical portion 4B.

According to the above configuration, the chip-on-board light emitting diode 50 is fixed to the front cylindrical portion 4B of the hammer case 4 via the light cover 57.

In the present embodiment, the impact tool 1 may include the light cover 57 including the light transmission portion 57C through which light emitted from the LED chip 52 of the chip-on-board light emitting diode 50 passes. The heat dissipation member may include the light cover 57.

According to the above configuration, the heat of the chip-on-board light emitting diode 50 is efficiently dissipated through the light cover 57.

In the present embodiment, the substrate 51 may have the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respect to the circular ring portion 51A. The light transmission portion 57C may be disposed so as to connect the front end portion of the outer cylindrical portion 57A and the front end portion of the inner cylindrical portion 57B. The substrate 51 may be in contact with at least one of the outer cylindrical portion 57A and the inner cylindrical portion 57B in a state of being spaced apart from the light transmission portion 57C.

According to the above configuration, the heat of the chip-on-board light emitting diode 50 is efficiently transferred to the light cover 57.

In the present embodiment, the substrate 51 of the chip-on-board light emitting diode 50 may be fixed to the heat dissipation member via the adhesive 59. The heat of the chip-on-board light emitting diode 50 may be transferred to the heat dissipation member via the adhesive 59.

According to the above configuration, the heat of the chip-on-board light emitting diode 50 is efficiently transmitted to the heat dissipation member via the adhesive 59.

In the present embodiment, the impact tool 1 may include the light cover 57 including the light transmission portion 57C through which light emitted from the LED chip 52 of the chip-on-board light emitting diode 50 passes. The heat dissipation member may include the light cover 57.

According to the above configuration, the heat of the chip-on-board light emitting diode 50 is efficiently transferred to the light cover 57 via the adhesive 59.

In the present embodiment, the substrate 51 may include the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respect to the circular ring portion 51A. The light transmission portion 57C may be disposed so as to connect the front end portion of the outer cylindrical portion 57A and the front end portion of the inner cylindrical portion 57B. The substrate 51 may be fixed to the inner cylindrical portion 57B via the adhesive 59.

According to the above configuration, the heat of the chip-on-board light emitting diode 50 is efficiently transferred to the light cover 57 via the adhesive 59.

### Second Embodiment

A second embodiment will be described. In the following description, the same or equivalent components as those of the above-described embodiment are denoted by the same reference signs, and the description of the components is simplified or omitted.

Power Tool

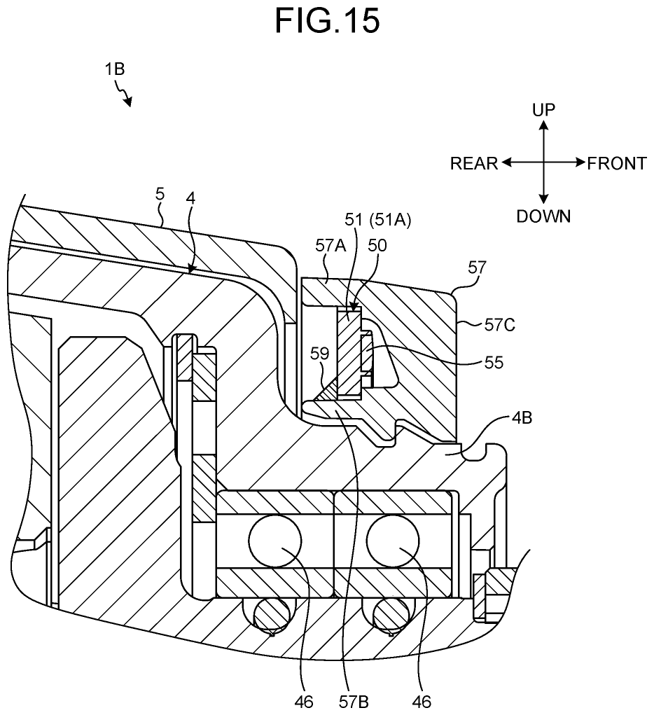

FIG. 15 is a cross-sectional view illustrating a part of a power tool 1B according to the present embodiment. The power tool 1B is an impact tool 1B. In the above-described embodiment, the substrate 51 and the hammer case 4 are connected via the thermal interface sheet 60. In the present embodiment, as illustrated in FIG. 15, a thermal interface sheet 60 is omitted, and a substrate 51 and a hammer case 4 are spaced apart from each other.

In the present embodiment, a heat dissipation member includes a light cover 57. The light cover 57 is in contact with the substrate 51. The substrate 51 is in contact with at least one of the outer cylindrical portion 57A and the inner cylindrical portion 57B in a state of being spaced apart from the light transmission portion 57C. Heat of a chip-on-board light emitting diode 50 is transferred to the light cover 57. The heat of the chip-on-board light emitting diode 50 transferred to the light cover 57 is dissipated to an atmospheric space around the light cover 57. As a result, an excessive rise in temperature of the chip-on-board light emitting diode 50 is suppressed.

Similar to the above-described embodiment, the substrate 51 of the chip-on-board light emitting diode 50 is fixed to the light cover 57 via an adhesive 59. The heat of the chip-on-board light emitting diode 50 may be transferred to the light cover 57 via the adhesive 59.

Effects

As described above, in the present embodiment, the substrate 51 is spaced apart from the hammer case 4 and the case cover 5. The heat dissipation member may include the light cover 57.

According to the above configuration, the heat of the chip-on-board light emitting diode 50 is efficiently dissipated through the light cover 57.

In the present embodiment, the substrate 51 may have the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respect to the circular ring portion 51A. The light transmission portion 57C may be disposed so as to connect the front end portion of the outer cylindrical portion 57A and the front end portion of the inner cylindrical portion 57B. The substrate 51 may be in contact with at least one of the outer cylindrical portion 57A and the inner cylindrical portion 57B in a state of being spaced apart from the light transmission portion 57C.

According to the above configuration, the heat of the chip-on-board light emitting diode 50 is efficiently transferred to the light cover 57.

In the present embodiment, the substrate 51 of the chip-on-board light emitting diode 50 may be fixed to the light cover 57 via the adhesive 59. The heat of the chip-on-board light emitting diode 50 may be transferred to the light cover 57 via the adhesive 59.

According to the above configuration, the heat of the chip-on-board light emitting diode 50 is efficiently transferred to the light cover 57 via the adhesive 59.

In the present embodiment, the substrate 51 may include the circular ring portion 51A, and the LED chip 52 may be disposed on the front surface of the circular ring portion 51A. The light cover 57 may include: the outer cylindrical portion 57A disposed radially outside with respect to the circular ring portion 51A; and the inner cylindrical portion 57B disposed radially inside with respect to the circular ring portion 51A. The light transmission portion 57C may be disposed so as to connect the front end portion of the outer cylindrical portion 57A and the front end portion of the inner cylindrical portion 57B. The substrate 51 may be fixed to the inner cylindrical portion 57B via the adhesive 59.

According to the above configuration, the heat of the chip-on-board light emitting diode 50 is efficiently transferred to the light cover 57 via the adhesive 59.

### Third Embodiment

A third embodiment will be described. In the following description, the same or equivalent components as those of the above-described embodiment are denoted by the same reference signs, and the description of the components is simplified or omitted.

Power Tool

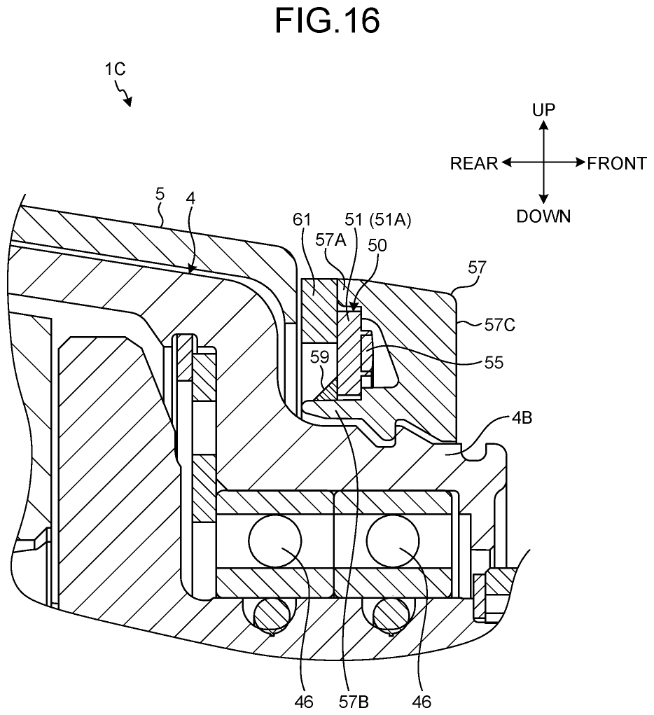

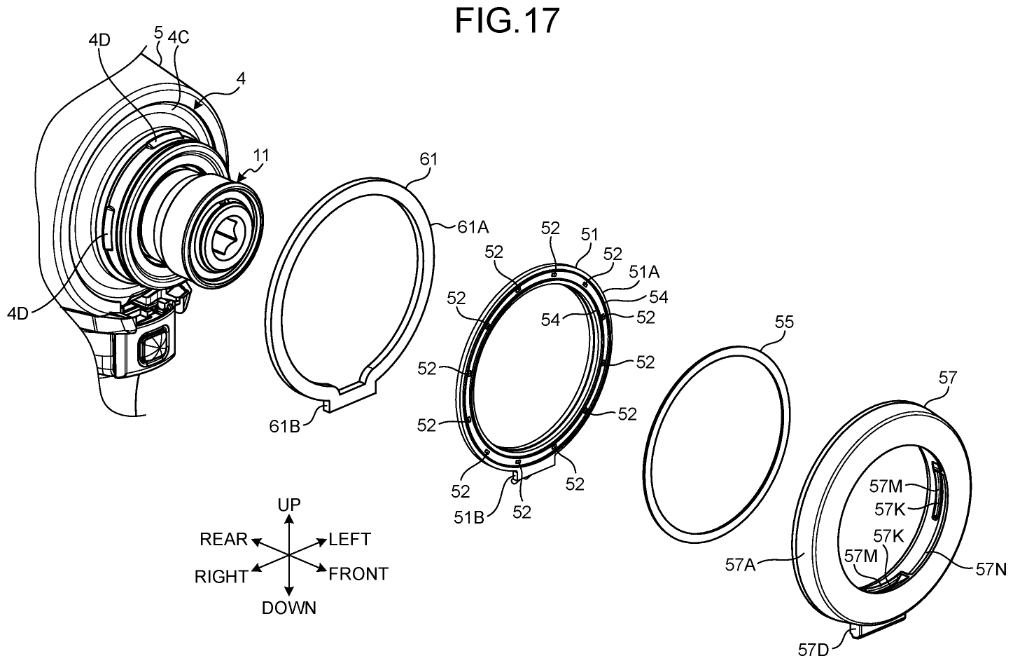

FIG. 16 is a cross-sectional view illustrating a part of a power tool 1C according to the present embodiment. FIG. 17 is an exploded oblique view, viewed from the front, which illustrates an upper portion of the power tool 1C according to the present embodiment.

In the present embodiment, the impact tool 1C includes a heat sink 61 connected to a chip-on-board light emitting diode 50. The heat sink 61 is disposed so as to be in contact with a rear surface of a substrate 51.

The heat sink 61 has an annular shape. The heat sink 61 has a thin plate shape. The heat sink 61 is made of metal. Examples of the metal forming the heat sink 61 include aluminum and magnesium. The thermal conductivity of the heat sink 61 is higher than the thermal conductivity of the light cover 57.

The heat sink 61 includes: a circular ring portion 61A, which is in contact with a rear surface of a circular ring portion 51A of the substrate 51; and a protrusion 61B, which is in contact with a rear surface of a support portion 51B of the substrate 51. The protrusion 61B protrudes downward from a lower portion of the circular ring portion 61A.

The heat sink 61 faces each of a hammer case 4 and a case cover 5 with a gap interposed therebetween. The heat sink 61 faces an annular portion 4C of the hammer case 4 with a gap interposed therebetween. The heat sink 61 faces a front end portion of the case cover 5 with a gap interposed therebetween. That is, a rear surface of the heat sink 61 is spaced apart from each of the hammer case 4 and the case cover 5. The rear surface of the heat sink 61 is in contact with the atmosphere.

The heat of the chip-on-board light emitting diode 50 is transferred to the heat sink 61. The heat of the chip-on-board light emitting diode 50 transferred to the heat sink 61 is dissipated to an atmospheric space around the heat sink 61. As a result, the temperature of the chip-on-board light emitting diode 50 is suppressed from excessively increasing.

Effects

As described above, in the present embodiment, the heat dissipation member is the heat sink 61, which is in contact with the substrate 51 of the chip-on-board light emitting diode 50.

According to the above configuration, the heat of the chip-on-board light emitting diode 50 is efficiently transferred to the heat sink 61.

In the present embodiment, the LED chip 52 of the chip-on-board light emitting diode 50 may be disposed on a front surface of the substrate 51. The heat sink 61 may be in contact with a rear surface of the substrate 51.

According to the above configuration, the heat of the chip-on-board light emitting diode 50 is efficiently dissipated through the heat sink 61.

In the present embodiment, the hammer case 4 may include: a rear cylindrical portion 4A that accommodates therein a speed reduction mechanism 7; a front cylindrical portion 4B that holds a bearing that supports an anvil 10; and the annular portion 4C that connects a front end portion of the rear cylindrical portion 4A and a rear end portion of the front cylindrical portion 4B. The chip-on-board light emitting diode 50 may be disposed around the front cylindrical portion 4B. The heat sink 61 may face the annular portion 4C with a gap interposed therebetween.

According to the above configuration, the heat of the chip-on-board light emitting diode 50 is efficiently dissipated to the atmospheric space via the heat sink 61.

In the present embodiment, the impact tool 1C may include the case cover 5 that covers a surface of the rear cylindrical portion 4A. The heat sink 61 may face the case cover 5 with a gap interposed therebetween.

According to the above configuration, the heat of the chip-on-board light emitting diode 50 is efficiently dissipated to the atmospheric space via the heat sink 61.

### Fourth Embodiment

A fourth embodiment will be described. In the following description, the same or equivalent components as those of the above-described embodiment are denoted by the same reference signs, and the description of the components is simplified or omitted.

Power Tool

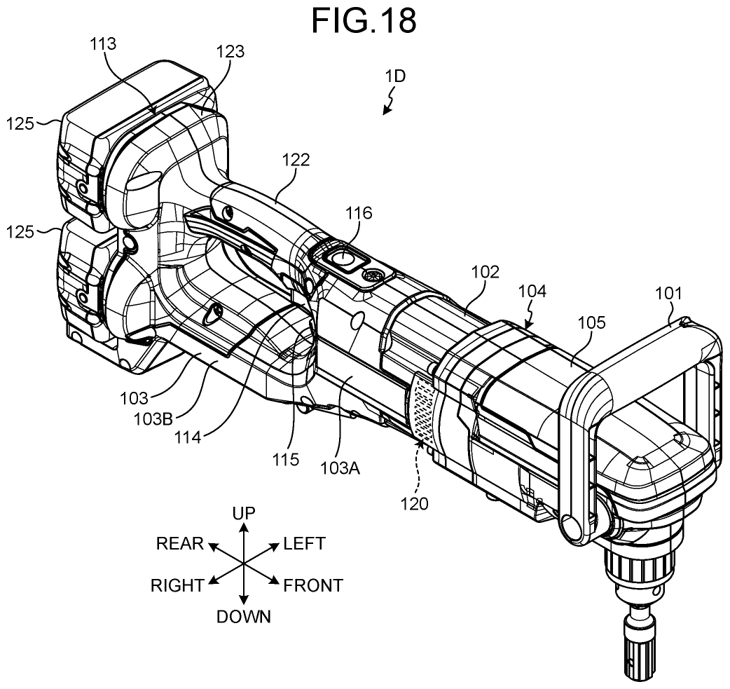

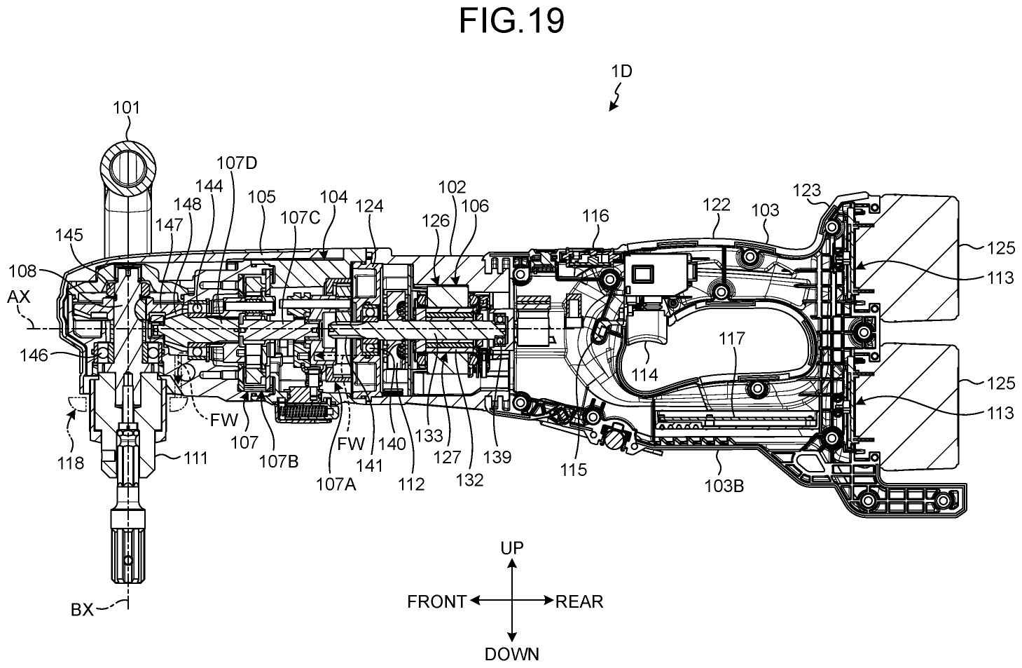

FIG. 18 is an oblique view, viewed from the front, which illustrates a power tool 1D according to the present embodiment. FIG. 19 is a cross-sectional view illustrating the power tool 1D according to the present embodiment. In the present embodiment, the power tool 1D is an angle drill which is a type of power tool. In the following description, the power tool 1D is appropriately referred to as an angle drill 1D.

The angle drill 1D includes a motor housing 102, a handle housing 103, a gear case 104, a cover 105, a front grip 101, battery mounting units 113, a controller 117, a main switch 116, a trigger lever 114, a forward/reverse switching lever 115, a motor 106, a bearing box 124, a fan 112, a speed reduction mechanism 107, a spindle 108, and a drill chuck 111.

The motor housing 102 houses the motor 106. The handle housing 103 is disposed rearward of the motor housing 102. A front portion of the handle housing 103 is connected to a rear portion of the motor housing 102. The handle housing 103 has a loop shape, which is long in the front-rear direction. The handle housing 103 includes: a front portion 103A connected to the rear portion of the motor housing 102; a grip portion 122 extending rearward from an upper portion of the front portion 103A; a controller housing portion 103B extending rearward from a lower portion of the front portion 103A; and a battery holder 123 connecting a rear end portion of the grip portion 122 and a rear end portion of the controller housing portion 103B. The grip portion 122 is disposed above the controller housing portion 103B. The grip portion 122 is disposed rearward of the motor housing 102. An operator can hold the grip portion 122 therein the speed reduction mechanism 107. The gear case 104 has a cylindrical shape. The gear case 104 is disposed in front of the motor housing 102. A rear portion of the gear case 104 is connected to a front portion of the motor housing 102. The gear case 104 is made of aluminum. At least a part of a surface of the gear case 104 is covered with the cover 105. In the embodiment, the cover 105 has a two-layer structure of synthetic resin and elastomer.

The front grip 101 is fixed to the gear case 104. The operator can grip the front grip 101.

The battery mounting units 113 are disposed at a rear portion of the handle housing 103. Battery packs 125 are respectively mounted on the battery mounting units 113. The battery mounting units 113 are provided in the battery holder 123 of the handle housing 103. In the present embodiment, two battery mounting units 113 are provided in the vertical direction. By respectively mounting the battery packs 125 on the two battery mounting units 113, the two battery packs 125 are disposed in the vertical direction. Each of the battery packs 125 is detachable from the battery mounting unit 113. After being mounted on the battery mounting units 113, the battery packs 125 can supply electric power to the angle drill 1D.

The controller 117 outputs control signals for controlling the angle drill 1D. The controller housing portion 103B has an internal space capable of housing the controller 117. The controller 117 is housed in the controller housing portion 103B.

The main switch 116 is operated by an operator to activate the angle drill 1D. The main switch 116 is provided on an upper portion of the front portion 103A. In response to operation of the main switch 116, power is supplied from the battery packs 125 to the controller 117, and the angle drill 1D is activated. The angle drill 1D is changed between activation state and stoppage state in response to the operation of the main switch 116.

The trigger lever 114 is operated by an operator to start the motor 106. The trigger lever 114 is provided on the grip portion 122. The trigger lever 114 protrudes downward from a lower portion of a front portion of the grip portion 122. The operator can operate the trigger lever 114 with his/her fingers so that the trigger lever 114 moves upward while gripping the grip portion 122 with one of the left and right hands. When the trigger lever 114 is operated to be pulled upward in a state where the angle drill 1D is activated, electric power is supplied from the battery packs 125 to the motor 106, and the motor 106 is activated. The motor 106 is changed between driving and stoppage in response to the operation (pull and release) of the trigger lever 114.

The forward/reverse switching lever 115 is operated by an operator to change a rotation direction of the motor 106. The forward/reverse switching lever 115 is provided in the front portion 103A. When the forward/reverse switching lever 115 is operated in the left-right direction, the rotation direction of the motor 106 is changed from one of a forward rotation direction and a reverse rotation direction to the other. When the rotation direction of the motor 106 is changed, the rotation direction of the spindle 108 is changed from one of the forward rotation direction and the reverse rotation direction to the other.

The motor 106 generates a rotational force for rotating the spindle 108. The motor 106 is driven owing to electric power supplied from the battery packs 125. The motor 106 is an inner-rotor-type brushless motor. The motor 106 includes a cylindrical stator 126 and a rotor 127 disposed inside the stator 126. A rotation axis AX of the rotor 127 extends in the front-rear direction. The rotor 127 includes a rotor shaft 133 and a cylindrical rotor core 132 disposed around the rotor shaft 133. A rear portion of the rotor shaft 133 is rotatably supported by a rotor bearing 139. A front portion of the rotor shaft 133 is rotatably supported by a rotor bearing 140.

The bearing box 124 holds the rotor bearing 140. The bearing box 124 is fixed to a rear end portion of the gear case 104.

The fan 112 is rotated by the rotational force of the motor 106. The fan 112 is attached to the rotor shaft 133 between the rotor bearing 140 and the stator 126. Air-exhaust ports 120 are provided in the motor housing 102. The air-exhaust ports 120 are disposed in a part of the periphery of the fan 112. When the rotor shaft 133 rotates and the fan 112 rotates, air in an interior space of the motor housing 102 is discharged to the outside of the motor housing 102 via the air-exhaust ports 120. The air discharged to the outside of the motor housing 102 through the air-exhaust ports 120 passes between the gear case 104 and the cover 105, and then is discharged from between the gear case 104 and the cover 105 so as to cool a light unit 118.

A pinion gear 141 is provided at a front end portion of the rotor shaft 133. The pinion gear 141 is disposed in an interior space of the gear case 104. The rotor shaft 133 is connected to the speed reduction mechanism 107 via the pinion gear 141.

The speed reduction mechanism 107 transmits the rotational force generated by the motor 106 to the spindle 108. The speed reduction mechanism 107 transmits the rotational force from the rotor shaft 133 to the spindle 108. The speed reduction mechanism 107 includes a plurality of gears. The speed reduction mechanism 107 includes a first planetary gear mechanism 107A, a second planetary gear mechanism 107B, a first intermediate shaft 107C, and a second intermediate shaft 107D.

The first planetary gear mechanism 107A is disposed forward of the rotor shaft 133. The first intermediate shaft 107C is disposed forward of the first planetary gear mechanism 107A. The second planetary gear mechanism 107B is disposed forward of the first intermediate shaft 107C. The second intermediate shaft 107D is disposed forward of the second planetary gear mechanism 107B. The second intermediate shaft 107D is rotatably supported by a bearing 144.

The spindle 108 is an output shaft of the angle drill 1D and is rotated by the rotational force of the motor 106. The spindle 108 rotates about a rotation axis BX. The rotation axis AX of the motor 106 and the rotation axis BX of the spindle 108 are orthogonal to each other. The spindle 108 is rotatably supported by a needle bearing 145 and a ball bearing 146. The needle bearing 145 supports an upper end portion of the spindle 108 in a rotatable manner. The ball bearing 146 supports a lower portion of the spindle 108 in a rotatable manner. A bevel gear 147 is provided at the upper end portion of the spindle 108. The bevel gear 147 meshes with a bevel gear 148 of the second intermediate shaft 107D. A diameter of the bevel gear 147 is larger than a diameter of the bevel gear 148. The number of teeth of the bevel gear 147 is larger than the number of teeth of the bevel gear 148.

The drill chuck 111 is mounted on a lower end portion of the spindle 108. A drill bit is attached to the drill chuck 111. The drill chuck 111 is rotatable with the drill bit attached thereto.

The light unit 118 is disposed around the spindle 108 and the drill chuck 111. Similar to the embodiments described above, the light unit 118 includes the chip-on-board light emitting diode 50 (not illustrated). The light unit 118 is fixed to the gear case 104. The substrate 51 of the chip-on-board light emitting diode 50 is fixed to the gear case 104. Power is supplied to the light unit 118 from the controller 117. A drive voltage of the light unit 118 is 5 V. A power supply cable connecting the chip-on-board light emitting diode 50 and the controller 117 passes between the gear case 104 and the cover 105.

The light flux of the light unit 118 is 50 lumens or more and 200 lumens or less. The light flux of the light unit 118 may be 80 lumens or more and 150 lumens or less, or may be 100 lumens or more and 130 lumens or less.

In the present embodiment, a heat dissipation device that dissipates the heat of the chip-on-board light emitting diode 50 includes the fan 112. When the fan 112 rotates, air is supplied from the fan 112 to the light unit 118 including the chip-on-board light emitting diode 50. As indicated by an arrow FW in FIG. 19, air from the fan 112 is discharged toward the light unit 118 via a space between the gear case 104 and the cover 105. In the present embodiment, a flow path is formed in a part of the gear case 104.

Effects

As described above, the angle drill 1D may include the fan 112 that is rotated by the rotational force of the motor 106. The heat dissipation device may include the fan 112. Air may be supplied from the fan 112 to the chip-on-board light emitting diode 50.

According to the above configuration, the heat of the chip-on-board light emitting diode 50 is dissipated by the air supplied from the fan 112.

### Fifth Embodiment

A fifth embodiment will be described. In the following description, the same or equivalent components as those of the above-described embodiment are denoted by the same reference signs, and the description of the components is simplified or omitted.

Light Unit

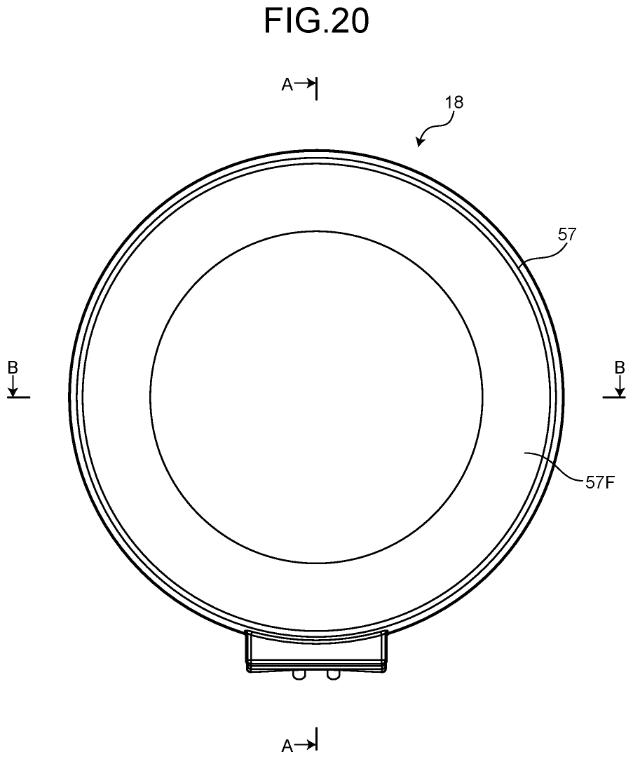

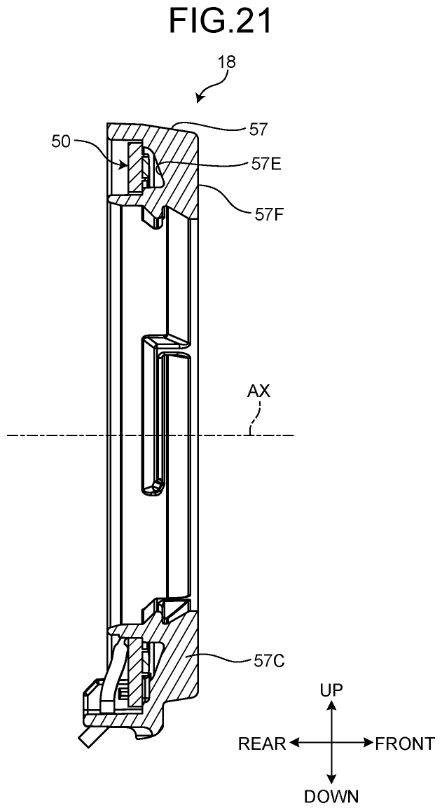

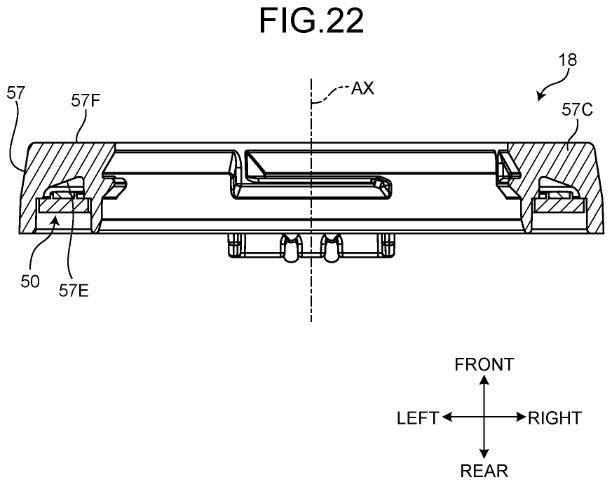

FIG. 20 is a front view of a light unit 18 according to the present embodiment. FIG. 21 is a longitudinal cross-sectional view illustrating the light unit 18 according to the present embodiment. FIG. 22 is a transverse cross-sectional view illustrating the light unit 18 according to the present embodiment. FIG. 21 is a cross-sectional view taken along line A-A in FIG. 20, and is a cross-sectional view parallel to a rotation axis AX of an anvil 10 and passing through the rotation axis AX. FIG. 22 is a cross-sectional view taken along line B-B in FIG. 20, and is a cross-sectional view parallel to the rotation axis AX of the anvil 10 and passing through the rotation axis AX.

As in the above-described embodiment, the light unit 18 includes a chip-on-board light emitting diode 50 and a light cover 57 (optical member). The light cover 57 is a thin white translucent light cover. The chip-on-board light emitting diode 50 includes a substrate 51 and a plurality of LED chips 52 (light emitting elements). The chip-on-board light emitting diode 50 is disposed around the anvil 10. Similar to the embodiments described above, the substrate 51 of the chip-on-board light emitting diode 50 is ring-shaped. The light cover 57 is disposed around the anvil 10. In FIGS. 20, 21, and 22, illustration of the anvil 10 is omitted.

The light cover 57 includes a light transmission portion 57C through which light emitted from the LED chips 52 passes. The light transmission portion 57C functions as a light refraction portion that refracts light emitted from the chip-on-board light emitting diode 50. The light transmission portion 57C has a ring shape. The light transmission portion 57C includes an entrance surface 57E on which light emitted from the LED chips 52 of the chip-on-board light emitting diode 50 is incident, and an exit surface 57F from which light transmitted through the light transmission portion 57C is output. In at least one cross section parallel to the rotation axis AX and passing through the rotation axis AX, a shape of the light transmission portion 57C is line-symmetric with respect to the rotation axis AX. At least each of the entrance surface 57E and the exit surface 57F is line-symmetric with respect to the rotation axis AX. In the embodiment, the entrance surface 57E is inclined rearward toward the radial outside. The exit surface 57F is orthogonal to an axis parallel to the rotation axis AX.

In the embodiment, in all cross sections parallel to the rotation axis AX and passing through the rotation axis AX, the shape of the light transmission portion 57C is line-symmetric with respect to the rotation axis AX.

Effects

As described above, in at least one cross section parallel to the rotation axis AX of the anvil 10 and passing through the rotation axis AX, the shape of the light transmission portion 57C is line-symmetric with respect to the rotation axis AX.

According to the above configuration, each of the chip-on-board light emitting diode 50 and the light transmission portion 57C of the light cover 57 has a ring shape arranged around the anvil 10, and the light transmission portion 57C is line-symmetric. Therefore, light is emitted from the light transmission portion 57C in a ring shape. This prevents a shadow from being formed on a work target.

The cross-sectional shape of the entire light cover 57 does not need to be line-symmetric with respect to the rotation axis AX, and it is sufficient that at least each of the entrance surface 57E and the exit surface 57F is line-symmetric with respect to the rotation axis AX.

In the present embodiment, the entrance surface 57E is inclined rearward toward the radial outside. The exit surface 57F is orthogonal to an axis parallel to the rotation axis AX. According to the above configuration, the light is appropriately spread from the light transmission portion 57C, and the work target is brightly illuminated.

In the present embodiment, in all cross sections parallel to the rotation axis AX and passing through the rotation axis AX, the shape of the light transmission portion 57C is line-symmetric with respect to the rotation axis AX.

According to the above configuration, in all the cross sections parallel to the rotation axis AX and passing through the rotation axis AX, the shape of the light transmission portion 57C is line-symmetric with respect to the rotation axis AX, whereby the light is emitted from the light transmission portion 57C in a ring shape. A work target is brightly illuminated by the chip-on-board light emitting diode 50.

### OTHER EMBODIMENTS

In the first, second, and third embodiments described above, the impact tool (e.g., the impact tool 1) is an impact driver. The impact tool (e.g., the impact tool 1) may be an impact wrench.

In the above-described embodiments, the power supply of the power tool (e.g., the impact tool 1) may not be the battery pack (e.g., the battery pack 25), and may be a commercial power supply (AC power supply).

In the above-described embodiments, the power tool (e.g., the impact tool 1) is an electric power tool using an electric motor as a power source. The power tool may be a pneumatic tool using an air motor as a power source. Furthermore, the power source of the power tool is not limited to the electric motor or the air motor, and may be another power source. The power source of the power tool may be, for example, a hydraulic motor or a motor driven by an engine.

According to one non-limiting aspect of the present disclosure, an excessive rise in temperature of the chip-on-board light emitting diode is suppressed. Furthermore, according to the above configuration, a shadow is suppressed from being formed on the work target.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power tool comprising:
a motor;
an output shaft that is rotated by a rotational force of the motor;
a chip-on-board light emitting diode disposed around the output shaft; and
a white translucent optical member including a light refraction portion that refracts light emitted from the chip-on-board light emitting diode, wherein
in at least one cross section parallel to a rotation axis of the output shaft and passing through the rotation axis, a shape of the light refraction portion is line-symmetric with respect to the rotation axis.

2. The power tool according to claim 1, wherein
the light refraction portion includes an entrance surface on which light emitted from the chip-on-board light emitting diode is incident and an exit surface from which light transmitted through the light refraction portion is output, and
each of the entrance surface and the exit surface is line-symmetric with respect to the rotation axis.

3. The power tool according to claim 2, wherein
the entrance surface is inclined rearward toward a radial outside, and
the exit surface is orthogonal to an axis parallel to the rotation axis.

4. The power tool according to claim 1, wherein
in all cross sections passing through the rotation axis, a shape of the light refraction portion is line-symmetric with respect to the rotation axis.

5. A power tool comprising:
a motor;
an output shaft that is rotated by a rotational force of the motor;
a chip-on-board light emitting diode disposed around the output shaft; and
a heat dissipation device that dissipates heat of the chip-on-board light emitting diode.

6. The power tool according to claim 5, wherein
the heat dissipation device includes a heat dissipation member to which heat of the chip-on-board light emitting diode is transferred.

7. The power tool according to claim 6, further comprising:
a speed reduction mechanism configured to transmit a rotational force of the motor to the output shaft; and
a gear case that accommodates therein the speed reduction mechanism, wherein
the heat dissipation member includes the gear case.

8. The power tool according to claim 7, further comprising
a thermal interface material that transfers heat of the chip-on-board light emitting diode to the gear case.

9. The power tool according to claim 8, wherein
the thermal interface material is in contact with a substrate of the chip-on-board light emitting diode and the gear case.

10. The power tool according to claim 9, wherein
the thermal interface material has a sheet shape.

11. The power tool according to claim 9, wherein
the gear case includes:
a rear cylindrical portion that accommodates therein the speed reduction mechanism;
a front cylindrical portion that holds a bearing that supports the output shaft; and
an annular portion that connects a front end portion of the rear cylindrical portion and a rear end portion of the front cylindrical portion,
the chip-on-board light emitting diode is disposed around the front cylindrical portion, and
the thermal interface material is in contact with the substrate and the annular portion.

12. The power tool according to claim 11, further comprising a case cover that covers a surface of the rear cylindrical portion, wherein
the heat dissipation member includes the case cover, and
the thermal interface material is in contact with the case cover.

13. The power tool according to claim 6, wherein
the heat dissipation member is in contact with a substrate of the chip-on-board light emitting diode.

14. The power tool according to claim 13, wherein
an LED chip of the chip-on-board light emitting diode is disposed on a front surface of the substrate, and
the heat dissipation member includes a heat sink that is in contact with a rear surface of the substrate.

15. The power tool according to claim 14, further comprising:
a speed reduction mechanism configured to transmit a rotational force of the motor to the output shaft; and
a gear case that accommodates therein the speed reduction mechanism, wherein
the gear case includes:
a rear cylindrical portion that accommodates therein the speed reduction mechanism;
a front cylindrical portion that holds a bearing that supports the output shaft; and
an annular portion that connects a front end portion of the rear cylindrical portion and a rear end portion of the front cylindrical portion,
the chip-on-board light emitting diode is disposed around the front cylindrical portion, and
the heat sink faces the annular portion with a gap interposed between the heat sink and the annular portion.

16. The power tool according to claim 13, further comprising a light cover including a light transmission portion through which light emitted from an LED chip of the chip-on-board light emitting diode passes, wherein
the heat dissipation member includes the light cover.

17. The power tool according to claim 6, wherein
a substrate of the chip-on-board light emitting diode is fixed to the heat dissipation member via an adhesive, and
heat of the chip-on-board light emitting diode is transferred to the heat dissipation member via the adhesive.

18. The power tool according to claim 11, wherein
the output shaft includes an anvil,
the power tool further comprises an impact mechanism to which a rotational force of the motor is transmitted via the speed reduction mechanism and that impacts the anvil in a rotation direction, and
the gear case is a hammer case that accommodates therein the speed reduction mechanism and the impact mechanism.

19. The power tool according to claim 15, wherein
the output shaft includes an anvil,
the power tool further comprises an impact mechanism to which a rotational force of the motor is transmitted via the speed reduction mechanism and that impacts the anvil in a rotation direction, and
the gear case is a hammer case that accommodates therein the speed reduction mechanism and the impact mechanism.

20. The power tool according to claim 5, further comprising a fan that is rotated by a rotational force of the motor, wherein
the heat dissipation device includes the fan, and
air is supplied from the fan to the chip-on-board light emitting diode.
